(19) United States
(12) Patent Application Publication
(10) Pub. No.: US 2026/0218693 A1
(43) Pub. Date: Jul. 30, 2026

(54) NEAR-ISOTHERMAL GAS COMPRESSOR AND/OR /EXPANDER SYSTEM

(71) Applicant: University of Virginia Patent Foundation, Charlottesville, VA (US)

(72) Inventor: Eric Loth, Charlottesville, VA (US)

(21) Appl. No.: 19/462,157

(22) Filed: Jan. 28, 2026

Related U.S. Application Data
(60) Provisional application No. 63/751,309, filed on Jan. 30, 2025.

(51) Int. Cl. F04B 27/00; F04B 39/00; F04B 39/06; F04B 39/10; F04B 53/04

(52) U.S. Cl. CPC F04B 27/00; F04B 39/062; F04B 39/064; F04B 39/1013; F04B 53/04; F04B 39/0094

(57) ABSTRACT

The disclosure presents systems for near-isothermal processes for gas compressors and/or expanders using an internal liquid approach with spray and/or novel porous elements for reciprocating systems. Furthermore, it presents approaches for compressed air energy storage using isobaric reservoirs for onshore wind turbines using an underground pressurized reservoir coupled with a compensating surface water reservoir, and for offshore wind turbines using the monopile for the pressurized reservoir.

### CROSS REFERENCE TO RELATED APPLICATIONS

This application is related to and claims the benefit of U.S. Provisional Application 63/751,309 filed Jan. 30, 2025, the entire contents of which are herein incorporated by reference.

This application is also related to and cross-references International Patent Application Number PCT/US2024/036778, filed on Jul. 3, 2024, which claimed the benefit of U.S. Provisional Patent Application Nos. 63/512,226 and 63/647,957 filed Jul. 6, 2023 and May 15, 2024, respectively, and International Patent Application Number PCT/US2022/044620, filed on Sep. 23, 2022, which claims priority to U.S. Provisional Patent Application Nos. 63/248,124 and 63/305,734, filed on Sep. 24, 2021 and Feb. 2, 2022, respectively. All of the cited applications are herein incorporated by reference in their entirety.

### STATEMENT REGARDING FEDERALLY SPONSORED RESEARCH OR DEVELOPMENT

This invention was made with government support under 2324460 awarded by the National Science Foundation. The government has certain rights in the invention.

### TECHNICAL FIELD

The disclosure generally relates to a gas compression and to compressed air energy storage systems.

To facilitate near-isothermal compression and/or expansion, disclosed herein is a reciprocating piston-based near-isothermal gas compressor and/or expander. To provide high isothermal efficiency, the compression and/or expansion processes can be made nearly isothermal in a reciprocating system by including a liquid volume in the chamber for heat transfer, and this heat transfer can be enhanced with liquid droplets and/or porous elements within the chamber volume. This system can be used for any gas, e.g., for compressing air, natural gas, hydrogen, etc. This system can also be used for isobaric compressed gas energy storage, especially for integration with a wind farm or a wind turbine.

### BACKGROUND

Gas compressors and expanders are used in many industries. For example, compressed air is important for manufacturing while compressing natural gas and hydrogen is important for their transport and/or handling. Furthermore, compression is often needed for electrolytic manufacturing of hydrogen. In addition, compressed gas energy storage can provide improved firmness for electrical grids and can be used to provide energy storage for wind farms.

However, conventional gas compressors can be inefficient in terms of the power needed to reach a given elevated pressure ratio due to the rise of the gas temperature accompanying the compression. This temperature rise can also be problematic in terms of handling the compressed gas. For example, natural gas compressors along a pipeline typically limit their pressure ratio to ensure that the temperature rise across the compressors is not too high since high gas temperatures can damage the pipeline protective coatings. As a result, multiple stages for a compressor (with interstage coolers) are sometimes needed to avoid the high temperature of the outgoing gas. However, a large number of stages can increase complexity and cost. Therefore, a compressor that avoids a large gas temperature rise will be more efficient and can handle larger pressure ratios with fewer stages. As such, a near-isothermal compressor, i.e., one which operates at nearly constant temperature, may be advantageous for gas compression.

Similarly, expanders can be inefficient in terms of power extraction since reducing gas pressure typically results in a drop of the gas temperature that reduces the available work output compares to an expander which operates at constant temperature. These work output can be maximized if the expansion process is nearly isothermal and/or employs stored thermal energy.

For systems that include both compressors and expanders, e.g., compressed air energy storage systems, nearly-isothermal compression combined with nearly-isothermal expansion, i.e., at nearly-constant temperature for both processes, can increase the overall round-trip efficiency. The expansion efficiency can be further increased by incorporating thermal energy storage and/or waste heat.

A near-isothermal processes for a compression and expansion may be achieved with reciprocating systems with high heat transfer within the cylinder that is enabled liquid sprays and/or by a Liquid Layer And Meshes with Mechanical Piston (LLAMMP) approach as described in PCT/US2024/036778).

### BRIEF SUMMARY

The disclosure presents a system for near-isothermal processes for reciprocating gas compressors and/or expanders. The compression and/or expansion processes can be used for any gas (e.g., natural gas, hydrogen, etc.) and can be applied for a wide range of rotations speeds (not limited by gravitational acceleration). The compressor and/or expander can be single-stage or multi-stage and can have one or more cylinders per stage.

Still further, each compressor and/or expander cylinder chamber disclosed will have at least one Low-Pressure Valve (LPV) that can be used for receiving or exhausting gas at a lower pressure.

Still further, each compressor and/or expander cylinder chambers disclosed will have at least one High-Pressure Valve (HPV) that can be used for receiving or exhausting gas at a higher pressure.

As proposed herein, several novel concepts can improve the effectiveness and/or reduce cost for reciprocating near-isothermal gas compression and/or expansion. These novel concepts generally include internal liquid in the chamber for heat transfer, where this heat transfer can be enhanced by a liquid droplet and/or porous elements in the chamber. This heat transfer provided by the internal liquid may be further enhanced at high piston accelerations since this can cause the internal liquid to breakup and/or be more distributed throughout the internal chamber volume.

For sprays used in conjunction with internal liquid in the chamber, the spray(s) droplets may be released in one or more bursts or in a continuous fashion. The spray nozzles may be disposed within the cylinder volume using direct injection and/or released upstream of the chamber using pre-mixed injection. The aloft droplets can provide heat transfer with the gas. For the case of pre-mixed droplet injection, the intake valves can be configured to spin about their axis of symmetry as the droplet-laden flow enters the chamber so that the swirling gas motion reduces the number of droplets that impact on the valve surface.

For porous elements used in conjunction with a liquid in the chamber, the elements can be secured immovably within the cylinder volume and designed to be completely (or nearly completely) immersed by the liquid when the piston is at Top Dead Center (TDC, where piston face is closes to the cylinder head). These elements can include one or more layers of vertical tubes and/or honeycomb cells. The porous elements can also include grids composed of vertical slats whose arrangement in a horizontal cross-section be based on straight lines, wavy lines, concentric circles and/or radial lines. The porous layers can include an offset or a gap in between layers to promote boundary layer restart. The porous elements can also be angled to promote a liquid swirl velocity within the chamber, where this swirl may help reduce sloshing and minimize liquid impact on the valves in the cylinder head. In addition, smaller/fine grids and/or denser porous layers can be used near the top to minimize gas clearance volume, to help prevent liquid in the chamber from impacting and/or entering the valves placed in the cylinder head, and to maximize heat transfer area near TDC.

Still further, the compressor and/or expander cylinder chambers disclosed may employ a single-stage system or a multiple-stage system, which involve different heat transfer strategies. For example, an initial (lower pressure) stage compression may employ a spray approach while a later (higher pressure) stage may employ a porous element approach.

In an additional embodiment, the compression cycle valve timing can be adjusted to allow the piston to recede from TDC with the low-pressure valve closed until the gas pressure in the chamber has reduced to a level at or just below that of the low-pressure intake gas.

In a further embodiment, the compressor and/or expander cylinder chambers may have one or more pressure dampers and/or emergency relief valves to avoid overpressure that can be caused by the presence of liquid in the cylinder.

In a further embodiment, one or more of the cylinder casings for the compressor and/or expander is composed of a material with good thermal conductivity and a liquid jacket to facilitate heat transfer. In addition, a liquid drain valve and/or a liquid feed valve can be placed near the top of the chamber to adjust the liquid volume in the chamber as needed.

In another embodiment, a piston rod may be integrated within the compression/expansion chamber which passes through the center of the cylinder head (through a piston rod port) so that a connecting rod and crankshaft can be placed above the piston. In this way, the stresses of the connecting rods will more likely be in tension than in compression, which can reduce the structural mass of the connecting rods, which can reduce costs.

In another embodiment, this connecting rod can be further partially or fully replaced by a connecting cable or cables if the maximum upward piston acceleration is less than that of gravitational acceleration.

Spray-based heat transfer may also be used in conjunction for an individual stage of a screw or centrifugal compressor as well as for an individual stage of a screw or radial turbine. The spray nozzles may be disposed upstream of a stage for pre-mixed droplet injection with a significant mass flow rate of the liquid, e.g. 5% or more relative to the air mass flow rate.

In addition, for compressed gas energy storage, underground storage can be made isobaric or nearly isobaric by employing hydrostatic pressure from a surface water reservoir. During gas discharge from this underground reservoir, the pressure-compensated water from this surface reservoir can enter the underground reservoir to keep the gas pressure nearly constant.

For a pressure-compensated water column, a key issue is the champagne-effect, whereby air dissolved into liquid at high pressure will escape lost once that liquid is brought to the surface at low pressure. This is problematic because the work that went into compressing this air is then lost. To avoid or minimize this problem, the water in this underground reservoir can be contained within a flexible bladder. Using such an impermeable bladder interface can prevent high pressure gas dissolution in the water. This bladder can also help prevent this reservoir water from eroding the reservoir walls (especially if the reservoir is mined in salt and the surface water is freshwater or low salinity water). This bladder can also help prevent underground contaminants from entering the surface water reservoir (especially if the reservoir is an abandoned coal mine and may contain mine acid). For an abandoned coal mine, it may also be helpful to line the coal mine walls with concrete or other material to reduce permeability and provide support.

As further embodiments, the compensating water can be heated to store thermal energy from gas compression and/or from waste heat from the compressed air energy system and/or nearby electrical equipment. The water may be fresh water or salt water. The compensating water can also be set to have a nearly similar temperature as that of the gas in the underground reservoir in order to minimize gas temperature variations and to minimize thermal stresses on the underground reservoir walls and structure. The stored thermal energy from the reservoir and/or from the gas in the reservoir can also be used to increase the available work output during gas expansion.

If the compressed gas energy system is located near or in water (e.g., at an offshore wind farm), isobaric or near-isobaric compressed energy storage can instead be enabled by employing one or more hydraulic turbines driven by the liquid leaving the storage chamber where the turbine shaft power can be used to drive one or more gas compressors which support high pressure gas to enter the storage chamber and/or can be enabled for gas discharging by employing one or more hydraulic pumps that drive liquid into the storage chamber where the pump shaft power is obtained by one or more gas expanders driven by high pressure gas leaving the storage chamber.

As an additional embodiment, an underground compressed air energy can be located at a wind farm to take advantage the wind farm transformer and grid connections that are part of the wind farm. Such a compressed air energy storage system can also take advantage of waste heat from farm-level equipment (transformers, turbines, generators, gearboxes, etc.).

In further embodiments, the compressor and/or expanders can be integrated in an individual wind turbine to take advantage of the wind turbine systems (gearbox, generator, and/or transformer) for the compressed air energy system. For example, one or more stages of a gas compressor can be driven by the low-speed rotor main shaft or to the high-speed generator shaft or to one of the shafts and/or gears in the gearbox. Furthermore, one or more stages of a gas expander can be used to send shaft power to the electrical generator. In addition, one or more stages of a gas expander may use waste heat from those wind turbine systems (turbine gearbox, generator, transformer and/or transformer) to increase work output during expansion.

Another option is to locate the compressors and/or expanders in the base of the tower, where some or all of the compressor/expander cylinders for one or more of the stages can be connected to the drive train in the nacelle by a cable system. This cable system may be allowed to twist within the tower to accommodate yawing of the nacelle.

Further embodiments for such a turbine integrated system include pneumatic and/or hydraulic lines in the nacelle (which rotates via yawing) that can be connected to similar lines in the tower (which is stationary) by a coiled flexible lines within the tower or can pass down along the tower centerline with a swivel connection so the electrical lines are instead coiled around the pneumatic and/or hydraulic lines. The pneumatic lines can be used to transport pressurized gas whereas the hydraulic lines can be used to transport heat exchanger fluid (which may also be pressurized).

For additional embodiments, a heat exchanger volume can be located after one or more gas compression stages and/or before one or more gas expansion stages. For gas compression, the heat exchanger volume can be configured so that the warmer gas inflow to the chamber is at or near the top and the cooler gas outflow is at or near the bottom. For gas expansion, the heat exchanger volume can be configured so that the cooler gas inflow to the chamber is at or near the bottom and the warmer gas outflow is at or near the top. In addition, the tower and/or monopile internal volume can also be used as a compressed air reservoir. In addition, a heat exchanger volume may be wrapped around the tower and/or in the monopile to benefit from wind-assisted convective heat transfer and to take advantage of the large thermal capacity of the tower shell.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIG. 1 Longitudinal (e.g., vertical) cross-sectional view of a conventional reciprocating compressor and/or expander with four inline vertical cylinders driven by a crankshaft below, where the pistons are connected to the rotating crankshaft by connecting rods and where the top of the cylinder is a cylinder head that can include valves to let gas in and to let gas out.

FIGS. 2A-D Longitudinal cross-sectional view of a single cylinder chamber with valves and a reciprocating piston showing piston location and valve conditions at different times during a compression cycle including: FIG. 2A, draw in of low-pressure gas as piston recedes to Bottom Dead Center (BDC, where piston face is farthest from the cylinder head) with Low-Pressure Valve (LPV) open and High-Pressure Valve (HPV) closed, FIG. 2B, piston reaches BDC and chamber is full and ready for compression to start once all valves are closed, FIG. 2C, compression of gas finishes (gas pressure reaches the desired value) as piston reaches GX (Gas Exchange) position, and FIG. 2D, push-out of high-pressure gas with HPV open and LPV closed as piston moves towards Top Dead center (TDC, where piston face is closest to the cylinder head).

FIGS. 3A-D Longitudinal cross-sectional view as in FIG. 2 but for an expansion cycle including: FIG. 3A, draw-in of high-pressure gas as piston recedes from TDC with HPV open and LPV closed, FIG. 3B, after draw-in process is complete (piston reaches GX position), expansion of the gas (to a lower pressure) starts as piston moves downward with LPV and HPV closed, FIG. 3C, expansion is complete when piston is at or near BDC, and FIG. 3D, push-out of low-pressure gas as piston moves to Top Dead Center with LPV open and HPV closed.

FIGS. 4A-D View as in FIG. 2 but with the addition of internal liquid volume and porous elements inside the chamber showing: FIG. 4A, draw in of low-pressure gas as the piston recedes to BDC, FIG. 4B, piston reaches BDC so the chamber gas volume is maximized and some or all of the liquid rests on top of the piston face, FIG. 4C, compression of gas is finished as piston reaches GX position where some of the porous elements may be submerged by the internal liquid, and FIG. 4D, push-out of high-pressure gas as piston moves to TDC where all or nearly all of the porous elements are submerged by the internal liquid.

FIGS. 5A-D View as in FIG. 3 but with the addition of internal liquid and porous elements inside the chamber showing: FIG. 5A, draw-in of high-pressure gas as the piston recedes from TDC to the GX position, FIG. 5B, expansion of the gas (to a lower pressure) begins after piston reaches the GX position, FIG. 5C, gas expansion is complete when piston is at or near BDC at which time some or all of the liquid rests on top of the piston face, and FIG. 5D, push-out of low-pressure gas as piston (and much of the liquid) moves to TDC.

FIGS. 6A-B Options for porous elements that can be used as layers include: FIG. 6A, woven-wire mesh layer (viewed from above and side) with wire diameter (dₘ), mesh spacing (sₘ), and mesh height (Hₘ), and FIG. 6B, honeycomb layer showing cell side length (sₘ), and mesh height (Hₘ).

FIGS. 7A-B Lateral (e.g., horizontal) cross-sectional view of cylinder chamber showing porous element configurations options: FIG. 7A, internal tube passages with diameter (sₘ) and FIG. 7B, wavy vertical slats with average plate spacing (sₘ).

FIGS. 8A-B View as in FIG. 7 but showing of vertical slats in the form of FIG. 8A, concentric circles and FIG. 8B, radial lines, which can be used as one or more of the porous element layers.

FIGS. 9A-D Views as in FIG. 4 but with the addition of liquid droplets (instead of porous elements) inside the chamber showing the option of direct injection spraying during a compression cycle.

FIG. 10A-D Views as in FIG. 5 but with the addition of liquid droplets (instead of porous elements) inside the chamber showing the option of direct injection spraying during an expansion cycle.

FIG. 11 Longitudinal cross-sectional view of chamber showing a drain valve close on the upper sidewalls that can be submerged by the liquid when the piston is at TDC, a pressure relief valve and/or pressure pulsation damper on the cylinder head, and an optional liquid feed valve.

FIGS. 12A-C An inlet or outlet valve with a Poppet-style configuration showing: FIG. 12A, a closed valve configuration with a cylindrical gas flow passage around the valve stem, which is currently blocked, FIG. 12B, an open configuration where the valve rotates about its axis of symmetry (V-V), FIG. 12C, a configuration as in FIG. 12B except that the gas flow passage is at an angle to the valve stem axis of symmetry.

FIG. 13 Longitudinal view as in FIG. 11 showing a liquid heat exchanger jacket around the cylinder casing configured to provide convective heat transfer between the casing and the liquid.

FIGS. 14A-C Cross sections of a cylinder with a double-acting compressor where both left and right chambers have volumes to compress gas and include internal liquid, showing: FIG. 14A, vertical cross-sectional for left chamber showing gas and liquid, FIG. 14B, vertical cross section along cylinder length, and FIG. 14C, vertical cross-sectional for left chamber showing recessed valve configuration to help minimize clearance (dead) volume.

FIGS. 15A-B Longitudinal view as in FIG. 14B showing configurations with FIG. 15A, pre-mixed droplet injection, and FIG. 15B, internal porous elements which are located on the left and the right ends beyond the range of the piston motion.

FIG. 16 Longitudinal cross-sectional view of a reciprocating compressor and/or expander with four inline vertical cylinders as shown in FIG. 1, except driven with a crankshaft above, where piston rods are used to connect the pistons to connecting rods, which are connected to the rotating crankshaft and where the top of the cylinder is a cylinder head that can include valves to let gas in and to let gas out and a port for the piston rod.

FIG. 17 Lateral cross-sectional view of cylinder head showing a piston rod port in the center, two ports for low pressure valves, two ports for high pressure valves, and one port for a pressure relief valve and/or accumulator damper.

FIG. 18 Spray pre-mixer pipe with spray nozzles located along the side walls to provide high mass loading droplet spray that enters a compressor stage or a turbine stage.

FIG. 19A-B Heat exchanger volume showing flow path: FIG. A, for cooling, where the warmer gas enters at or near the top and the cooler gas exists at or near the bottom and FIG. B, for warming, where the cooler gas enters at or near the bottom and the warmer gas exits at or near the top.

FIG. 20 Schematic of the conventional Advanced Adiabatic Compressed Air Energy Storage (AACAES) system where electrical energy from the grid (through a voltage step-down transformer) during charging is used to power to motors for compressors, which provide pressurized gas to an underground reservoir along with thermal heat to a hot water storage tank, and where energy discharging returns the pressurized air to the surface so that turbines connected to generators (and using the stored thermal energy) can provide electrical energy back to the grid (through a voltage step-up transformer), and where the underground gas pressure can be held nearly constant by using a compensating surface water reservoir connected to a vertical shaft and to the underground reservoir.

FIG. 21 Schematic of the fluid and thermal flow of a typical AACAES system where energy charging is accomplished with three stages of adiabatic compression and heat exchanger volumes are employed after each compression stage to heat water coming from the cold water storage tanks and going to the hot water storage tanks (which are typically pressurized) where the pressurized air is sent to an underground reservoir for storage and where energy discharging is accomplished by expanding the pressurized air through three stages of adiabatic expansion with heat exchanger volumes before each expansion stage using the heat water coming from the hot water storage tanks and going to the cold water storage tanks.

FIG. 22 Schematic of a Near-Isothermal Compressed Air Energy Storage (ICAES) system which differs from FIG. 20 in that there are no cold nor hot water storage tanks, and where the water in the underground reservoir is encased in a flexible bladder to prevent high-pressure gas dissolving into this water.

FIG. 23 Schematic of the fluid and thermal flow for the ICAES system where energy charging is accomplished with two stages of near-isothermal compression using internal spray and/or external liquid jacket cooling during each compression stage (with heat exchanger for the air after each compression stage and for the heat exchanger before returning to the its reservoir) to supply pressurized air to an underground reservoir and where energy discharging is accomplished by expanding the pressurized air through two near-isothermal expansion stages (which are the compression stages running in reverse) using internal spray and/or external liquid jacket warming (with a heat exchanger for the air before each expansion stage and for the heat exchanger before returning to the its reservoir).

FIG. 24 Underground isobaric compressed gas storage as in FIG. 22 but with the addition of a wind farm to provide electrical energy to the compressed air energy storage system during charging (instead of using the electrical energy from the grid with a step-down transformer).

FIG. 25 System component comparison of an AACAES system for grid-level energy storage with a Wind-based Isothermal Compressed Air Energy Storage (WICAES) system for wind farm energy storage, where both use a surface water reservoir to allow underground isobaric storage but WICAES uses electricity produced by the wind farm during energy storage and a near-isothermal compressor/expander and avoids the need for a step-down transformer and also avoids the need for a conventional Thermal Energy Storage System by employing near-isothermal compression and expansion.

FIG. 26 System component comparison as in FIG. 25 but now with a Wind-based Advanced Isothermal Compressed Air Energy Storage (WAICAES) system, which harvests waste heat from the farm-level systems (e.g., transformer, motor, generator, gearboxes, reciprocating compressors) and/or from gas compression to supply thermal energy to the hot water reservoir and where thermal energy from the hot water reservoir can be used to heat the air for expansion either directly or indirectly (by using an intermediary heat exchanger liquid).

FIG. 27 Schematic of the fluid and thermal flow for a WAICAES system during energy charging, which is similar to FIG. 23 except that the air coming out of the final compressor stage and farm system waste heat are used to provide thermal energy to the hot water reservoir and that the air in the underground reservoir has a similar hot temperature as that of the surface hot water reservoir.

FIG. 28 Schematic of the fluid and thermal flow for a WAICAES system during energy storage, which is similar to FIG. 23 storage except that the farm system waste heat is used to provide thermal energy to the hot water reservoir.

FIG. 29 Schematic of the fluid and thermal flow for a WAICAES system during energy discharging (with the reciprocating compressors acting in reverse as expanders), which is similar to FIG. 23 discharging except that the farm system waste heat is used to provide thermal energy to the hot water reservoir and the reservoir heat is used to help heat the gas before and during expansion.

FIG. 30 System component comparison of an AACAES system for grid-level energy storage with a Turbine-integrated Advanced Isothermal Compressed Air Energy Storage (TAICAES) system for wind turbine energy storage, which can harvest waste heat from the turbine-level systems (e.g., gearbox, generator, transformer) to provide heat before or during air expansion stages and where isobaric compressed air energy storage can be located underground or in the wind turbine monopile.

FIG. 31 Schematic of the fluid and thermal flow for a TAICAES system as in FIG. 23, except now includes a turbine-level heat recovery system during energy discharging to harvest waste heat from the systems in a turbine (e.g., gearbox, generator, transformer) to supply thermal energy to the reciprocating expanders (which are the reciprocating compressors acting in reverse) and now includes the option of compressed gas storage in the turbine monopile.

FIG. 32 Side view of a conventional onshore geared wind turbine where the nacelle will yaw (rotate about the vertical axis) as the wind changes direction so the rotor faces the wind while the tower and foundation are stationary, where the electrical cables can twist as the nacelle rotates and a drip loop just below the nacelle is used to accommodate this cable twist and nacelle yaw.

FIG. 33 A closeup of the nacelle and tower top of a conventional onshore geared wind turbine showing the hub for the rotor blades, whose rotation drives the Low-Speed Shaft (LSS) that is supported by two main bearings, where this shaft power is connected to a gearbox, which typically includes a Low-Speed Intermediate Shaft (LSIS) and a High-Speed Intermediate Shaft (HSIS), followed by a High-Speed Shaft (HSS) that drives an electric generator which is connected to a medium-voltage transformer, and where these components are mounted on a bedplate that can be driven by a yaw motor to rotate the bedplate in a horizontal plane about the stationary tower so that the rotor is aligned with the oncoming wind.

FIG. 34A closeup of the nacelle and tower top as in FIG. 33 but with the addition of compression and/or expansion cylinders whose crankshafts are connected through gearing to the High-Speed Intermediate Shaft and where four cylinders are used to provide a High-Pressure (HP) stage and four other cylinders are used to provide a Low-Pressure (LP) stage.

FIG. 35 A closeup of the nacelle and tower top as in FIG. 33 but with the addition of a Top Bullwheel connected to the Low-Speed Intermediate Shaft which carries a drive cable that is directed down the wind turbine tower by sheaves including a sheave ring that is attached to the bedplate and thus rotates/yaws with the bedplate.

FIG. 36 An intermediate portion of a wind turbine tower with a sheave ring that can rotate to allow the drive cable to twist (to accommodate bedplate yaw) and a sheave spacer to prevent the upward and downward moving cables from coming in contact with each other.

FIG. 37 The base of a wind turbine tower with sheaves that align the drive cable to the Bottom Bullwheel, which drives four High-Pressure (HP) and four Low Pressure (LP) cylinders for compression and/or expansion.

FIG. 38A-B Options to include pneumatic and/or hydraulic line(s) that pass from the yawing nacelle to the tower, showing: FIG. A, side view of a wind turbine as in FIG. 32 but with the addition of by coiling inside the top shell of the turbine tower, and FIG. B, a closeup of the nacelle and tower top where the pneumatic and/or hydraulic line(s) are wrapped around a wrap mesh to prevent from coming in direct contact with the electrical cables.

FIG. 39 Isobaric compressed air storage in an offshore wind turbine monopile with a two-stage compression during energy charge where a second-stage compressor is driven by a hydraulic turbine powered by the high-pressure water leaving the storage chamber (where the volumetric flow rate of water that leaves the storage volume matches or nearly matches the volumetric flow rate of the pressurized air that enters the storage volume so the storage pressure remains approximately constant).

FIG. 40 Isobaric compressed air storage as in FIG. 39 but during energy discharge where a second-stage expander drives a hydraulic pump so that water enters the pressurized storage chamber into a flexible bladder.

### DETAILED DESCRIPTION

1.1 Conventional Compressor and/or Expander Configurations

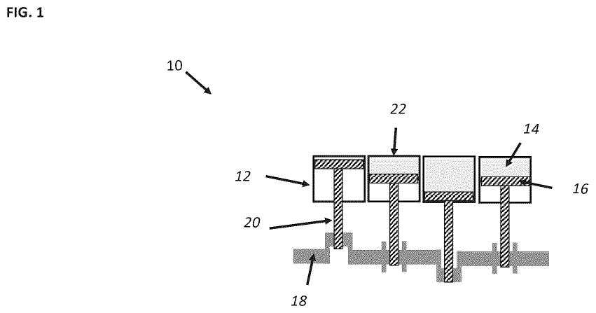

A compressor and/or expander may be used for compressing and/or expanding gas, e.g., air, natural gas, or hydrogen. The compression and/or expansion can be accomplished in one or more stages. One option is to use a reciprocating system with one or more piston chambers for each stage. For example, a single-stage system 10 could include a straight-4 orientation (four cylinders 12 in line) as shown in FIG. 1, which is a common cylinder arrangement for internal combustion car engines. Often such cylinders are vertical, e.g., the cylinder axis of symmetry is vertical and a lateral cross-section is along a horizontal plane. By having a timing offset between cylinders (some pistons are moving downward and some are moving upward) the shaft power can be smoothed out. For example, a two-stage system with four inline cylinders could include two first-stage (low-pressure) cylinders and two second-stage (high-pressure) cylinders. Other cylinder options could include inline options (e.g., a straight-6, straight-8, etc.) and V configurations (e.g., V-4, V-6, etc.). The cylinders can also be double-acting and/or horizontal. For example, a common arrangement for high pressure compressors (to provide 30 bar or more pressurized gas) is to employ multiple stages of double-acting reciprocating compressors with a horizontal balance-opposed frame, where the cylinders are horizontal and are often water-cooled. Herein, we describe unique aspects of a new near-isothermal reciprocating concept using the example of a straight-4 configuration, but most of these aspects will generally apply to all the above options, including multi-stage double-acting reciprocating compressors using a horizontal balance-opposed frame. Later, we describe a new near-isothermal concept for centrifugal compressors.

For a piston-based system on a crankshaft 18, each cylinder 12 can be driven by a piston 16 which is linked to the crankshaft 18 by a connecting rod 20 as shown in FIG. 1. The piston 16 advances towards a cylinder head 22 (half the cycle time) and then recedes towards the crankshaft 18 (the other half of the cycle time). The total time for a full downstroke and a full upstroke of the piston 16 is the cycle time (t_{cycle}). The cycle time in seconds can be related to the crankshaft RPM as:

$${t}_{c y c l e} = ( 60 sec / min ) / RPM$$

A slow RPM can have several benefits. A low RPM (slow speed) can allow for increased heat transfer to occur, and reduce the gas velocities through the valves and through the flow lines, which reduces the fluid dynamic pressure losses. Furthermore, slow speeds allow the valve timings to be more precise (relative to the cycle time period) and allow conventional valve cams to be more easily replaced by electro-hydraulic, electro-mechanical, or electromagnetic valves. This can save system weight for the valve system while also allowing increased control and variability of valve timing. However, a slow RPM can have several disadvantages. Slow speeds have long cycle times that result in large displacement volumes and high torques, which can increase the overall mass of the compressor and/or expander system, which can increase cost. Furthermore, conventional electric motors and generators tend to operate at high RPM values. Therefore, the system speed should be a balance between these tradeoffs.

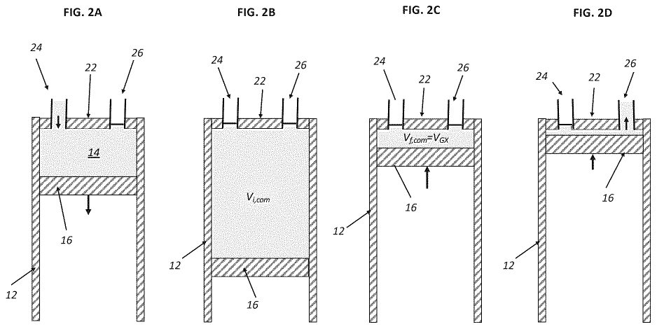

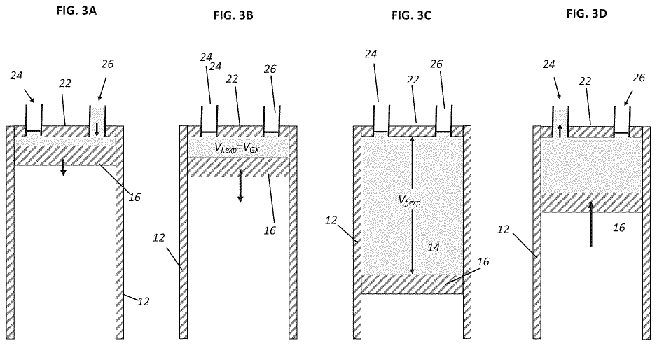

The cylinder head 22 for the single-stage single-action vertical reciprocating compressor system 10 may be connected by flow lines to both low-pressure and high-pressure gas as shown by the sectional views in FIGS. 2A-D for compression and FIG. 3A-D for expansion. In these two figures, the connection to the low-pressure gas is controlled by a Low-Pressure Valve (LPV) 24 while the connection to the high-pressure gas is controlled by a High-Pressure Valve (HPV) 26. These valves can be ring valves, plate valves, and/or Poppet valves. In general, the cylinder head 22 can have one or more LPVs 24 and one or more HPVs 26 but for simplification, we consider a single LPV 24 and a single HPV 26 in the illustrated embodiments. The operation of these valves 24, 26 in coordination with the piston 16 motion using a two-stroke cycle can be used for compressing gas as shown in FIGS. 2A-D or for expanding gas as shown in FIGS. 3A-D. In the following description, the valve openings are assumed to occur instantaneously but, in reality, there will be finite (but ideally small) time for valve opening and closure as the piston is moving.

In addition, piston position is defined relative to a Top Dead Center (TDC) and a Bottom Dead Center (BDC). TDC occurs when the piston is at its maximum upwards advancement (minimum distance to the cylinder head) so that the chamber gas volume is minimized. See, e.g., FIG. 2D. BDC occurs when the piston recession is maximum (maximum distance from the cylinder head) so that the chamber gas volume is maximized. See, e.g., FIG. 2B. The internal cylinder chamber volume at BDC is defined as the chamber volume (V_{cham}).

For a compression cycle as shown in FIGS. 2A-D, the LPV 24 is open as the piston 16 recedes to BDC to draw in low pressure gas as shown in FIG. 2A. When the piston 16 is at or near BDC, the LPV 24 closes and compression initiates so the gas volume at this time is defined as the initial gas volume for compression (V_{i,com}) as shown in FIG. 2B. For maximum gas compression with no liquid in the chamber, this volume also equals the chamber volume (V_{i,com}=V_{cham}). The piston 16 then moves upward, and the compression is complete once when the pressure increases to the target pressure value. The gas volume at this time is the final gas volume for compression (V_{f,com}) as shown in FIG. 2C. The piston position at this time is defined herein as the Gas eXchange position (GX), since the HPV 26 opens so the high-pressure gas can be pushed out as the piston moves to TDC. The volumetric gas compression ratio (CR) is defined as the ratio of initial gas volume (just before compression) to the final gas volume (just after compression), which is also equal to the gas exchange volume (V_{GX}), i.e.

$$CR = {V}_{i , c o m} / {V}_{f , c o m} = {V}_{i , c o m} / {V}_{GX}$$

The HPV 26 opens when the piston 16 reaches the GX position (FIG. 2C) so that the high-pressure gas is pushed out as the piston 16 continuous to move upwards to TDC as shown in FIG. 2D. After the piston 16 is already at TDC and the HPV 26 has closed, the piston 16 begins to descend. If there is a volume of residual pressurized gas in the chamber 14 which did not get pushed out (dead gas volume), both valves 24, 26 can remain closed while the piston 16 descends from TDC until this residual gas pressure decreases and matches the low-pressure gas associated with the LPV 24. At this time, the LPV 24 opens as the piston 16 recedes and the compression process repeats.

Note that some dead gas volume is generally needed due to valve clearance. In general, dead gas volume should be minimized since it reduces the rated displacement volume and leads to power losses. Valve types that may be used to minimize dead volume include Poppet valves, plate valves and ring valves.

For an expansion cycle, the HPV 26 opens as the piston 16 recedes from TDC to GX to draw in high-pressure gas as shown in FIG. 3A. When the piston 16 recedes to the GX position as shown in FIG. 3B, the HPV 26 closes and the gas volume in the chamber is defined as the initial gas volume for expansion (V_{i,exp}). At this point, the HPV 26 closes so the gas expands as the piston continues to recede towards BDC. The gas volume continuous to expand with both LPV 24 and HPV 26 closed until the final expansion pressure is reached, yielding a final gas volume for expansion (V_{f,exp}) as shown in FIG. 3C. For maximum gas expansion (with no liquid in the chamber 14), this volume also equals the chamber volume (V_{f,exp}=V_{cham}). The volumetric gas expansion ratio (CR) is defined as the ratio of final gas volume to initial gas volume associated with expansion

$$ER = {V}_{f , exp} / {V}_{i , exp}$$

After expansion is complete, the LPV 24 opens so this low-pressure gas can be pushed out as the piston 16 moves to TDC as shown in FIG. 3D. After reaching or just before TDC, the LPV 24 closes, and the HPV 26 opens so the process repeats. One option is to close the LPV 24 before reaching TDC so the dead gas volume can be pressurized to match that of the high-pressure gas associated with the HPV 26.

This same concept can be extended to include multiple-stages, e.g. a two-stage system or a three-stage system. For a multiple-stage system, flow lines are needed to connect the stages. For the example of a two-stage system, the flow from the HPV 26 of the first stage is connected to the LPV 24 of the second stage. Furthermore, the connecting flow paths between stages can be opportunities for heat transfer to help promote near isothermal compression and/or expansion. For example, the flow lines can have external features (e.g., fins) and can have internal features (e.g., porous meshes) to promote heat transfer to the air surroundings. In addition, the flow path between two stages can include an interstage settling chamber to reduce pressure unsteadiness and increase heat transfer. The interstage settling chamber volume can also include a recirculating heat transfer liquid to enhance thermal capacity and mass transfer, e.g. the gas flow can be released below the liquid so that the gas bubbles through the liquid. However, multiple stages also add system complexity and maintenance issues. As such, performance and cost must both be considered when deciding the ideal number of stages.

Another approach to use for compression is a centrifugal compressor, which typically operates at a high RPM. For example, a centrifugal compressor stage with a pressure ratio of 3:1 may operate at a speed between 3,000 to 20,000 RPM. This fast speed typically results in adiabatic compression. A single stage of a centrifugal turbine (i.e. expander) or an axial turbine may operate at similar or even higher rotational speeds and again the process is typically adiabatic. Fogging the inflow with small droplets can be used to moderate the temperature increase upstream of a compressor where the ratio of liquid mass flow rate to gas flow rate is generally ranges from 0.5% to 4% and does not include interstage droplet injection. A similar fogging approach can be used upstream of a turbine, where again the ratio of liquid mass flow rate to gas flow rate generally ranges from 0.5% to 4% and does not include interstage droplet injection.

1.2 A Near-Isothermal Gas Compression and/or Expansion

In general, near-isothermal conditions will increase round-trip efficiency for compression and/or expansion. To achieve this, heat transfer to and from the ambient environment can be used during gas compression and expansion so that the gas temperature does not change significantly. One previous approach to obtain the heat transfer benefits is to employ a liquid piston system that uses internal heat exchanger elements. However, a liquid piston system can lead to a mismatch in hydraulic power vs. pneumatic power and requires an additional hydraulic pump system, which increases cost and reduces efficiency.

Herein, the heat transfer can be accomplished for a reciprocating system with a mechanical piston in conjunction with internal liquid to avoid the power mismatch, cost and efficiency losses of a hydraulic system. The proposed internal liquid within the chamber can enhance heat transfer between the gas and the chamber walls (casing, cylinder head and piston) by convective heat transfer as the liquid moves over these surfaces and can enhance heat transfer with the gas through breakup of the liquid due to piston movement. In addition, the internal liquid can serve to submerges sidewall spray nozzles and/or internal porous elements when the piston reaches TDC to minimize dead volume. Spray nozzles can be used to inject droplets in the chamber or upstream in the incoming flow so that the droplets in the chamber provide heat transfer from the gas to the liquid during compression and/or expansion. In addition, internal porous elements can be used, which significantly increase the surface area seen by the gas and liquid in the chamber to promote internal heat transfer and heat transfer with the chamber walls. The porous elements can also serve to protect the valves in the cylinder head from high-speed impact of liquids associated with piston movement and to minimize liquid from entering in the low-pressure and/or high-pressure valves.

The internal liquid can be water but can include other liquids as well. For example, additives or liquid mixtures can be used to help prevent freezing. Preventing freezing is especially important during expansion when the gas cools and/or when the ambient gas is below the freezing temperature of water. For example, the liquid can be a mixture of water with glycerine/glycerol since such a mixture can have a low freezing point, while maintaining relatively high specific heat and thermal conductivity. For example, a mixture of 40% glycerin and 60% water can be used, but mixtures with higher or lower glycerin fractions can also be used. Oil or other refrigerant liquids may also be used since they prevent freezing and corrosion while also enhancing lubrication. To minimize viscous losses, low viscosity liquids used such as PAO-2 (e.g., SpectraSyn™ 2), synthetic ester (e.g., Hatcol 2372), silicone fluid (e.g., DMS-T03), and PFPE fluid (e.g., Krytox™ 1506)

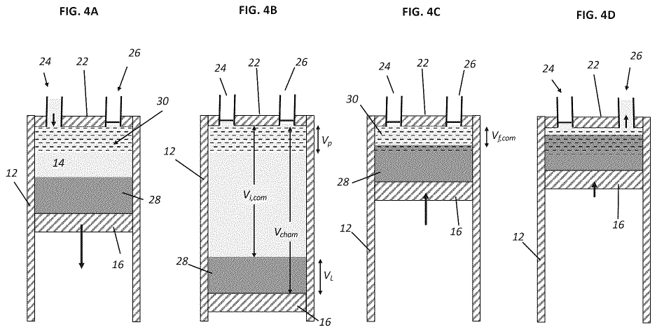

An example of the internal liquid approach with porous elements for a compression cycle is shown in FIG. 4A-D, following a similar sequence of events as shown in FIG. 2A-D. As in FIGS. 2A-D, we consider a single LPV 24 and a single HPV 26 and assume instantaneous valve opening and closing to simplify the figure discussion (whereas generally multiple LPV and multiple HPV can be employed, and these valves will require a finite time to close and open). As illustrated in FIG. 4A for a vertical configuration, the internal liquid 28 will tend to accumulate on the piston surface (especially for low piston speeds) while the fixed porous elements 30 will generally be located at the top of the cylinder volume, proximate to the cylinder head 22. Since any portion of the porous elements 30 that is submerged will not provide direct heat transfer to the gas, it may be beneficial to have a higher concentration of the porous elements 30 near the top of the cylinder to minimize submergence during the compression portion of the cycle. The chamber volume occupied by the porous elements (Vₚ) and the internal liquid volume (V_{L}) are shown in FIG. 4B. This liquid volume 28 should be large enough to submerge all or nearly all of the porous elements 30 when the piston 16 is at TDC as shown in FIG. 4D.

For the compression cycle, the LPV 24 is open as the piston 16 recedes to BDC to draw in low pressure gas as shown in FIG. 4A. The chamber 14 is filled with this low-pressure gas as the piston recedes toward BDC. Once the piston is at or near BDC, the LPV 24 closes so compression can begin as shown in FIG. 4B. FIG. 4B also shows the initial gas volume for compression (V_{i,com}) and the internal cylinder chamber volume at BDC (V_{cham}). If the LPV 24 closes at this same time, this gas volume equals the initial gas compression volume, i.e.

$${V}_{c h a m} ( gas and liquid ) = {V}_{i , c o m} ( gas ) + {V}_{L} ( liquid )$$

As the piston 16 moves upwards from BDC to GX during compression, it will cause gas to move upwards which will provide convective heat transfer with the porous elements. The heat transfer between the porous elements 30 and the gas can prevent significant gas temperature increases and promote more uniform gas temperature within the chamber 14.

FIG. 4C shows the piston 16 at the GX position for compression where (as in FIG. 2C) the gas transfer volume (V_{GX}) equals the final compression gas volume (V_{f,com}) and which occurs just after compression is finished and just before gas is transferred to the storage chamber. Since the compression power is generally highest just before the piston reaches the GX position, setting the porous volume to be larger than the gas exchange volume (Vₚ>V_{GX}) will increase the amount porous element surfaces 30 that are unsubmerged when the heat transfer to the gas is most needed (the power is highest). However, the submerged porous elements 30 can still be beneficial since they will have heat transfer with the internal liquid. In addition, thermal conductivity paths (primarily vertical connections) from the submerged porous elements 30 to the unsubmerged porous elements 30 will also help cool the unsubmerged porous elements, which can then help cool the gas.

After the piston reaches the GX position, the HPV 26 is opened, and the high-pressure gas is pushed out as shown in FIG. 4D. As pushout occurs, the liquid will generally submerge more of the porous elements. Once the piston reaches TDC, the HPV 26 is closed so pushout ends and the liquid fills all or most of the chamber to minimize dead gas volume. This dead gas volume can be minimized by placing valves at the maximum height within the chamber and designing the internal liquid layer volume to minimize gas below the valves. To take advantage of the residual pressurized gas in the chamber which did not get pushed out (dead volume) and for any pressurized gas dissolved within the internal liquid, both valves 24, 26 can remain closed while the piston 16 descends from TDC until the gas pressure drops to a level similar to that of the low-pressure gas associated with the LPV 24. At this time, the LPV 24 opens as the piston 16 recedes and the compression process repeats.

Since internal liquid is used to submerge all or nearly all of the chamber porous elements 30 after pushout, the internal liquid volume will generally be larger than the porous elements volume (V_{L}>Vₚ). As such, increasing Vₚ will generally increase heat transfer and increase isothermal efficiency. However, increasing Vₚ will lead to increasing V_{cham} (for a given V_{i,com}) which will generally increase system costs. Therefore, the optimum Vₚ generally requires a balance between cost and efficiency considerations.

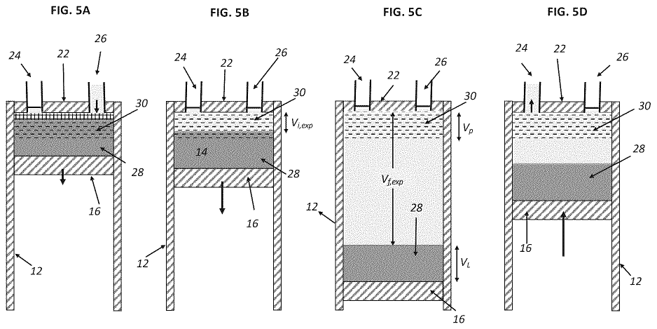

For the expansion process shown in FIG. 5A-D, the process is similar to that of FIG. 3A-D except for the addition of the porous elements 30 and the addition of the internal liquid 28. In particular, the chamber 14 fills with the high-pressure gas with the HPV 26 open as the piston 16 recedes allowing much of the internal liquid 28 to also recede as shown in FIG. 5A. Once the piston 16 reaches the GX position as shown in FIG. 5B, the HPV 26 then closes, and the gas expands, taking advantage of heat transfer with the unsubmerged porous elements 30 to keep a nearly-isothermal process. As shown in FIG. 5C, when the gas expansion is complete, the gas volume in the chamber is V_{f,exp}. If this occurs at BDC, the gas volume and the liquid volume equal the chamber volume.

$${V}_{c h a m} ( gas and liquid ) = {V}_{f , exp} ( gas ) + {V}_{L} ( liquid )$$

After reaching BDC, the LPV 24 opens and the piston 16 rises to exhaust the low-pressure gas out of the chamber 14 as shown in FIG. 5D. After reaching or just before reaching TDC, the LPV 24 closes and the HPV 26 opens so the process repeats. One option is to close the LPV 24 before reaching TDC so the dead gas volume can be pressurized to match that of the high-pressure gas associated with the HPV 26 and so that gas can be dissolved in the internal liquid 28 to prevent further dissolution when the HPV 26 is opened.

To minimize the potential for liquid entering the valve regions, one may reduce the combination of the RPM and stroke length so that the maximum piston acceleration is less than the gravitational acceleration. In this way, the internal liquid is more likely to form as a single layer on top of the piston surface during all times of compression and/or expansion. However, even when the maximum piston acceleration is smaller than gravity, unsteadiness of the liquid interface, such as sloshing, may occur. When approaching TDC, this interface unsteadiness can lead to increased dead volume and unwanted ingestion of liquid in the ambient and/or storage flow lines. The porous elements can be designed with vertical or near-vertical surfaces to minimize this sloshing (by damping lateral liquid movements), especially during the push-out portion of the compression cycle (and the pushout portion of the expansion cycle). Porous elements with vertical or near-vertical surfaces as well as smaller and/or more closely spaced elements located near the top of the chamber may be especially helpful at damping sloshing during the pushout. To further minimize sloshing, vertical baffles may be installed in the porous region and the cylinder head shape can be modified.

The heat exchanger elements should ideally have large thermal capacity, high thermal conductivity and good thermal connections to promote heat transfer. As such, materials with high thermal conductivity can be arranged to allow rapid thermal conduction from the gas to the cylinder walls, to the cylinder head, and to the internal liquid. For example, steel or aluminum may be good material candidates for the porous elements. Thermal conductivity can be ensured by thermally connecting the porous elements in multiple locations to the cylinder casing and/or the cylinder head and to each other can increase. These connections can include horizontal support structures between the heat exchanger elements and the cylinder casing as well as and/or vertical support structures between the heat exchanger elements and the cylinder head.

While many geometries are possible, the internal porous elements can be composed of horizontal, vertical, or angled porous layers or other porous geometries.

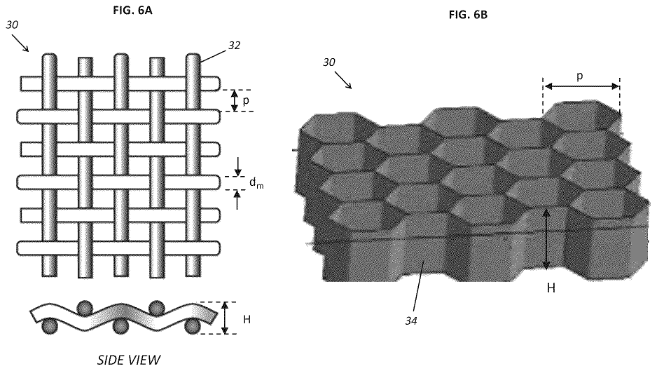

For example, the internal porous elements 30 may comprise layers of flat or woven wire meshes. For example, FIG. 6A shows a woven wire mesh with a mesh wire diameter dₘ, a pore size (p, center-to-center spacing), and a mesh thickness/height H. Such meshes 32 can be distributed across the cylinder chamber 14 in horizontal layers, either stacked on top of each other (to promote vertical thermal conductivity) or spaced vertically apart with a gap of distance gₘ (to promote boundary layer restart, which increases heat transfer). The gap characterized by dₘ, H, and p can be optimized to maximize heat transfer while avoiding large pressure drops.

In another embodiment, the internal fixed porous elements 30 may have a geometry structure comprising a honeycomb layer 34, as shown in FIG. 6B, which has a longitudinal height (height along the direction of the cylinder axis of symmetry) of H and a pore size of p. Such a honeycomb porous layer 34 can include a longitudinal gap gₘ in between layers to promote boundary layer restart.

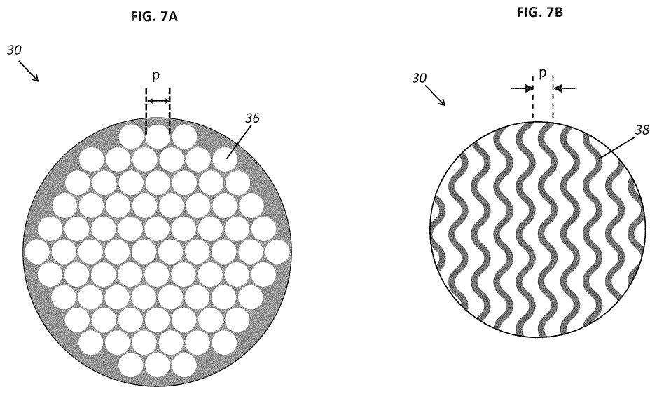

In another embodiment, the internal fixed porous elements 30 may have a geometry comprising a series of longitudinal circular tubes 36 as shown by the lateral cross-section in FIG. 7A, where the tubes 36 have a pore diameter p and a longitudinal height H.

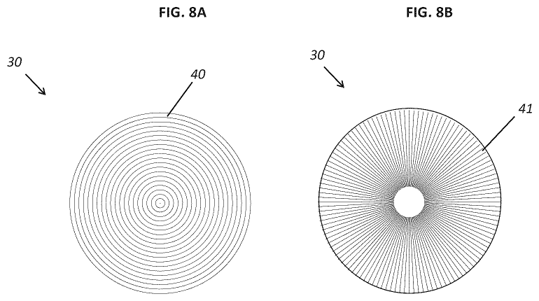

In still another embodiment, the internal fixed porous elements 30 may have a geometry comprising a layer of alternating wavy longitudinal slats 38, as shown in FIG. 7B, which can help reduce liquid hold up as compared to the wire meshes 32 or honeycombs 34 while providing more heat transfer area than simple straight walls. Such surfaces 38 can have a layer height of H and a pore size p based on the average spacing between longitudinal surfaces. The wavy surfaces 38 comprises a series of longitudinal surfaces which in cross-section comprise an alternating curvilinear shape, such as a sinusoidal curve, or a curved zig-zag pattern, or the like. Other exemplary geometries of the porous elements 30 include longitudinal slats along circular lines 40 or radial lines 41 as shown in FIGS. 8A-B. As with the honeycombs 34, a longitudinal gap can be included between sections of tubes and/or longitudinal slats to promote boundary layer restart.

Generally, a large number of porous elements can be used to increase the thermal capacity, available heat transfer surface area, and conductivity to the cylinder shell/head and/or the liquid layer. However, there can be problems if the porous volume becomes too large. First, this will cause an increase in the chamber volume, which can increase costs. Secondly, a large number of porous elements (especially with small pores) will increase pressure drop across the porous region, which results in increased lost work and therefore decreased efficiency. Since the lower portions of the porous volume will see the highest relative liquid velocities (which lead to pressure drop) and the upper portions will have the longest times in direct contact with the gas, the smallest pore sizes and longitudinal heights may be more ideally situated closer to the cylinder head.

For a given porous volume, the heat exchanger elements should ideally have small features to allow rapid thermal response. However, there can be problems if the mesh or pore size is too small. First, finer meshes may be less robust and can therefore be damaged or break, though use of strong materials like steel and aluminum can help prevent this issue. Second, very small pores may become clogged with particles over time, though this particle clogging can be prevented by carefully filtering all gas and liquids entering the cylinder chamber. Third, very small pores may result in liquid bridging that can problematically reduce the amount of porous surface area exposed to gas. This liquid bridging may be reduced with liquid repellent coatings on the porous elements, e.g., with Teflon-coated stainless-steel screens. Another approach to reduce this liquid bridging is to ensure the porous layers are sealed at the cylinder walls (e.g. by adding sealing support rings). Such sealing would minimize any gas gap between the porous elements and cylinder walls, so that the gas is axially forced through the porous regions (instead of going around them) during both compression and expansion. This gas forcing can help break up liquid bridges. In addition, evaporation (via electric heating) or vibration of the HX elements can be used to reduce liquid bridging.

In addition to using internal porous elements to provide internal heat transfer, spray-based heat transfer can also be used. In general, gas temperature changes will increase for adiabatic compression as the Pressure Ratio (PR) increases, where PR is defined as the ratio of outgoing pressure to incoming pressure for a compressor but is defined as the ratio of incoming pressure to outgoing pressure for a compressor. As discussed by Simpson et al. (2023a, 2023b), the ability to prevent gas temperature changes during compression or expansion for a given PR will be based on the droplet Mass Loading (ML, the mass of droplets in the air relative to the air mass), and the Crowe number (Cr, ratio of the droplet thermal response time, t_{dropT}, to the droplet-gas interaction time, tᵢₙₜ).

$$M L = {m}_{drops} / {m}_{air}$$

$$Cr = {t}_{dropT} / {t}_{int}$$

In these expressions, m_{drops} is the mass of droplets in the air, mₐᵢᵣ is the mass of air, t_{dropT} is the thermal response time of a single drop and tᵢₙₜ is the interaction time of a drop with the air (during compression or expansion). As discussed by Simpson et al. (2023a), the interaction time can be approximated as the minimum of the droplet trajectory in air (tₜᵣₐⱼ) and the time associated with air compression or expansion process (t_{proc}), i.e

$${t}_{int} = min ( {t}_{traj} , {t}_{p r o c} )$$

The average droplet thermal response time is defined (Loth, 2023) as

$${t}_{d ropT} = {r}_{drop} {c}_{drop} {d}_{drop}^{2} / ( 6 {k}_{a i r} N u )$$

In this expression, r_{drop} and c_{drop} are the density and specific heat of the droplet liquid, d_{drop} is the average droplet diameter, kₐᵢᵣ is the thermal conductivity of air and Nu is the droplet Nusselt number (=2 for spherical drops at small Reynolds numbers).

If the droplets generally stay along during compression or expansion, do not impact walls nor each other, the droplet-gas interaction time is equal to the process time, t_{proc}, i.e. the general Crowe number is defined

$${t}_{int} = {t}_{p r o c}$$

For a reciprocating compressor, the process time is the time associated with the compression stroke to complete in one cycle. For a reciprocating expander, the process time is the time associated with the expansion stroke to complete in one cycle. In both compression and expansion, a near-isothermal process is most readily achieved with high droplet mass loadings combined with low Crowe numbers, especially at large pressure ratios and if evaporation or condensation also occurs. If mass transfer also occurs, the heat transfer between drops and a gas can be further enhanced. For example, water droplets that evaporate during compression can lead to cooling while water droplets that condense during expansion can lead to warming.

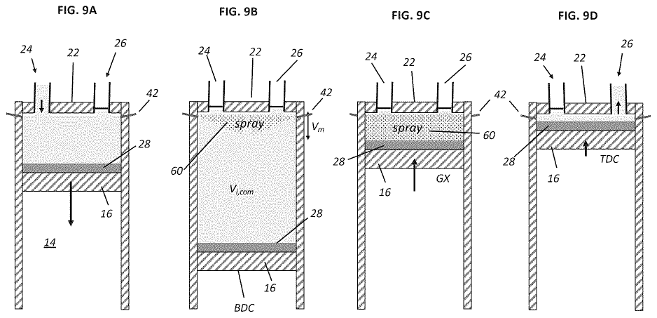

An example of the internal liquid approach with spray nozzles (without internal porous elements) for a compression cycle is shown in FIGS. 9A-D. Relative to the piston movement, the movement of the internal liquid and the operation of the valves is similar to that shown in FIGS. 4A-D. However, if there are no internal porous elements, the amount of internal liquid 28 can be reduced (as shown in FIG. 9 compared to that shown in FIG. 4). The liquid volume 28 can be sized such that it will submerge any spray nozzles 42 that are along the chamber sidewalls. In general, the spray(s) droplets 60 may be released in one or more bursts or in a continuous fashion by spray nozzles. The spray nozzles 42 may be disposed within the cylinder volume using direct injection and/or released upstream of the chamber using pre-mixed injection. For the case of pre-mixed droplet injection, the intake valves can be configured to spin about their axis of symmetry as the droplet-laden flow enters the chamber so that the swirl motion reduces the impact of droplets on the valve surface. While spray can be injected even before compression starts (as in the case of pre-mixed injection), it will generally be most important to have a significant number of droplets 60 aloft near the end of compression when the work rate is highest (Simpson et al., 2023a, 2023b). Therefore, the spray rate for direct injection may increase as the piston approaches the GX position.

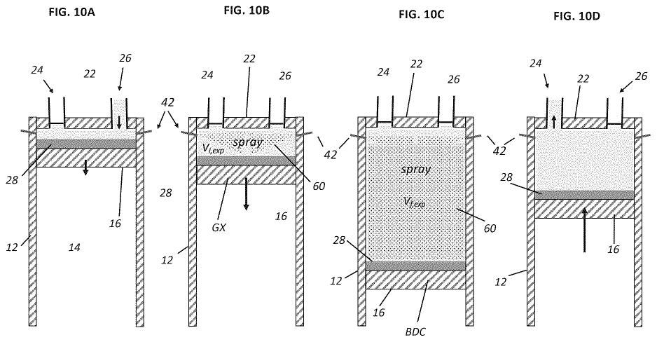

An example of the internal liquid approach with spray nozzles 42 for an expansion cycle is shown in FIGS. 10A-D. Relative to the piston movement, the movement of the internal liquid 28 and the operation of the valves 24, 26 is similar to that shown in FIGS. 5A-D. However, if there are no internal porous elements 30, the amount of internal liquid 28 can be reduced (as shown in FIG. 10 compared to that shown in FIG. 5). The liquid volume 28 can be sized such that it will submerge any spray nozzles 42 along the chamber sidewalls and the spray(s) droplets may be released in one or more bursts or in a continuous fashion. The spray nozzles 42 may be disposed along the cylinder walls for direct injection into the chamber 14 using and/or released upstream of the chamber inflow line using pre-mixed injection. It will generally be most important to have a significant number of droplets aloft near the start of expansion when the shaft power extraction is highest. Therefore, the spray rate for direct injection may occur before expansion starts.

If both porous elements 30 and direct injection spray nozzles 42 are used, it may be best to locate the spray nozzles 42 below the porous elements 30.

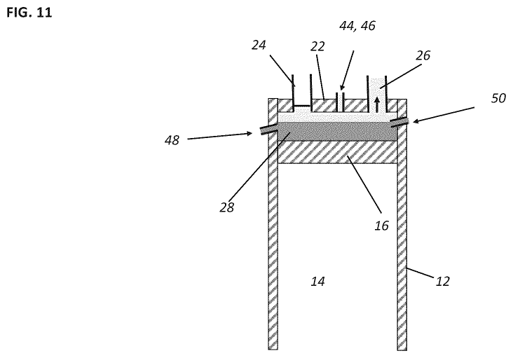

As noted above, the internal liquid volume is designed to occupy nearly all the chamber internal volume when the piston is at TDC to minimize dead gas volume. However, if there is a surplus of liquid volume in the chamber or large movement of the liquid, this can lead to a cylinder overpressure since liquids are generally incompressible. Cylinder overpressure is a well-known potential problem with liquid in reciprocating compressors since it can lead to high pressure spikes (e.g., via water hammer) at or near maximum compression due to the incompressibility of liquid. These pressure spikes can cause damage to the cylinder, the valves, connecting rods, and even the crankshaft. This overpressure issue can be addressed with fast-acting precision-control valves, e.g. valves with electro-hydraulic actuation. Moreover, use of multiple exit valves per cylinder (in case one valve gets stuck or has improper timing) can help ensure that over-pressure does not occur. As shown in FIG. 11, one or more pressure relief valves 44 and/or pressure pulsation dampers 46 (e.g. accumulator, hydro-pneumatic device, etc.) can be placed at the cylinder head 22 to ensure that the pressure in the chamber 14 does not exceed the safety limits of the piston 16 and the walls of the cylinder chamber 12. The pressure relief valves 44 and pressure pulsation dampers 46 can be similar to those used in conventional hydraulic pumps.

In addition, the volume of liquid 28 in the chamber 14 can be controlled through the use of a drain valve 48 (to reduce V_{L}) and a feed valve 50 (to increase V_{L}). As shown in FIG. 11, the drain valve 48 can be placed in the upper region of the chamber 14 so it can be submerged by the liquid 28 when the piston 16 is at TDC. After leaving the cylinder 12 through the drain valve, the internal chamber liquid 28 can be passed through a heat exchanger exposed to ambient conditions (e.g., facing the incoming wind) to return the liquid 28 to near ambient temperatures before being reinjected. In the case of expansion operation, the internal liquid 28 that is extracted by a drain valve 48 can also be passed through a heat exchanger that is associated with a gearbox and/or the generator to allow waste heat from the gearbox and/or the generator to heat the liquid 28 before it is returned to the chamber via the feed valve 50 and/or the spray nozzle 42. The liquid 28 can also be stored in a reservoir before returning to the cylinder 12. Liquid that does enters the low pressure or high-pressure flow lines can also be separated from the gas stream and sent to the reservoir and/or passed through a waste heat recovery system before being sent back to the chambers 12.

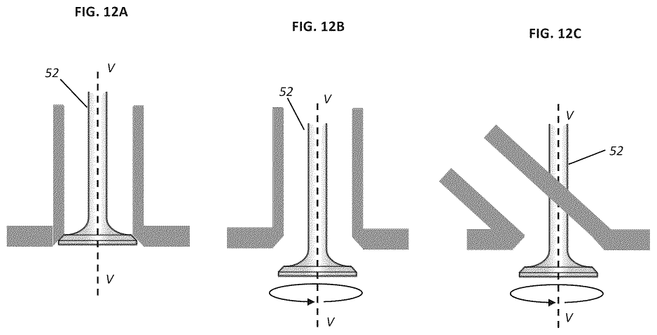

Intake valves for reciprocating systems can use Poppet and other similarly shaped valves 52, as shown in FIG. 12. For the case of pre-mixed droplet injection, the intake valves 52 can be configured to spin about their axis of symmetry V-V when open as the droplet-laden flow enters the chamber 14 (as shown in FIG. 12B). The spinning valve stems will induce rotation of the local gas in the valve chamber and this swirling gas motion can reduce the impact of droplets on the valve surface. The air flow path in the valve chamber can also be angled to the valve stem as shown in FIG. 12C to help minimize droplet impact on the valve surfaces.

In addition to internal heat transfer by internal porous elements and/or droplet sprays, heat transfer to the ambient surrounding air or liquid outside of the cylinder can be accomplished by using cylinder walls (cylinder sidewalls, cylinder head, and the piston) that are made of materials with high thermal conductivity and relatively low cost, e.g., aluminum or steel. This conductivity facilitates high conduction heat transfer between the internal and external cylinder surfaces. To also facilitate heat transfer between the external cylinder surfaces and the ambient gas flowing past the cylinders, external surface features, such as protruding fins, can be added on the external cylinder surfaces to increase the gas-exposed surface area. The internal cylinder head surface can also be corrugated or finned to increase heat transfer. In addition, vanes or internal surface features can be placed on the cylinder walls and/or cylinder head within the porous region to promote swirl of the internal liquid so that this liquid is less likely to enter the valves and/or the gas dead volume is reduced.

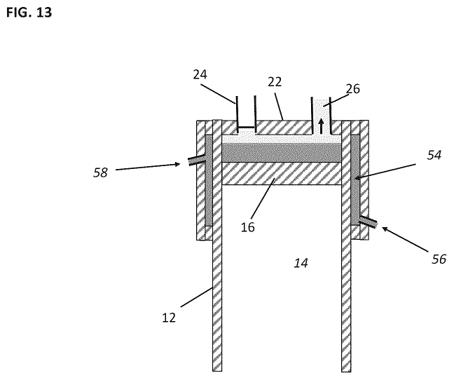

Another heat transfer option is to integrate liquid jackets 54 into or around the walls of the cylinder 12 as shown in FIG. 13. Liquid flowing through the passages of the liquid jacket 54 can provide high convective heat transfer to cool the cylinder walls during compression and to warm the vessel walls during expansion (making both gas processes more isothermal). After leaving the cylinder jacket 54, through an outflow valve 56, the jacket heat transfer liquid can be passed through a radiator exposed to ambient conditions (e.g., facing the incoming wind) to return the liquid to near ambient temperatures. In the case of compression operation, the jacket heat transfer liquid can be used to store thermal energy in a liquid reservoir. In the case of expansion operation, the jacket heat transfer liquid during expansion operation can also be passed through a heat exchanger associated with nearby systems producing waste heat (such as gearbox, generator, transformer etc.) to heat the liquid before it is returned to the liquid jacket 54 through a jacket inflow valve 58.

For example, the liquid jacket 54 can employ water as the heat transfer liquid but can include other liquids as well to help prevent freezing. Some examples include liquid mixtures (e.g. water mixed with glycerol), oils and refrigerant liquids. Preventing freezing is especially important during expansion when the gas cools and/or when the ambient conditions are below the freezing temperature of water. The liquid used in the liquid jacket 54 can also be the same type of liquid as used inside the chamber.

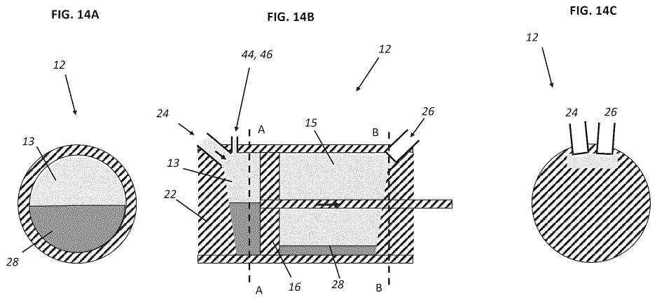

In conventional high-pressure reciprocating systems, double-action piston with a horizontal orientation for the cylinder axis of symmetry is often used. The internal liquid volume concept can be used for such a piston as shown in FIG. 14. In this case, the valve portions 24, 26 can be recessed to help minimize the dead volume as shown in FIG. 14B, which shows a left cylinder volume 13 and a right cylinder volume 15. FIG. 14A shows a vertical cross-section A-A of the left cylinder volume as the piston moves to the right to draw in low pressure gas with the left LPV open, while the right cylinder volume is compressing the gas with the right cylinder valves closed. FIG. 14C shows a vertical cross-section B-B of the right cylinder end which includes a recessed LPV and HPV.

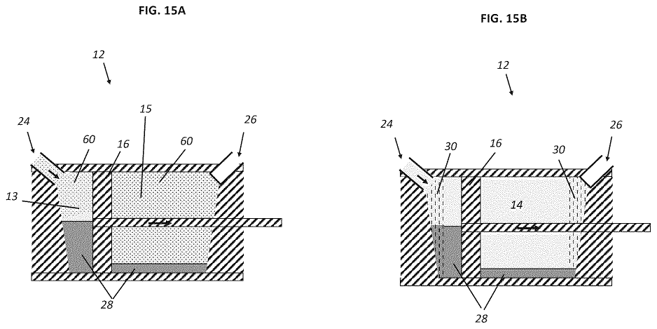

The above near-isothermal reciprocating concepts for spray heat transfer and porous elements can also be employed for a horizontal double-acting cylinder, as shown in FIGS. 15A-B, respectively. FIG. 15A shows the arrangement in which the left LPV 24 is opened (and left HPV is closed) to draw in low pressure gas that is pre-mixed with sprayed liquid droplets 60 into the left cylinder volume 13. FIG. 15A also shows a right cylinder volume 15 during compression in which the right LPV 24 and HPV 26 are both closed to compress gas with droplets 60. FIG. 15B is similar to FIG. 15A except the droplet sprays are replaced with shows the internal porous elements 30 disposed within the left and right cylinder chamber volumes 13 and 15 at opposite ends, i.e. with the porous elements proximate to the LPV 24 and HPV 26 for the respective cylinder volumes.

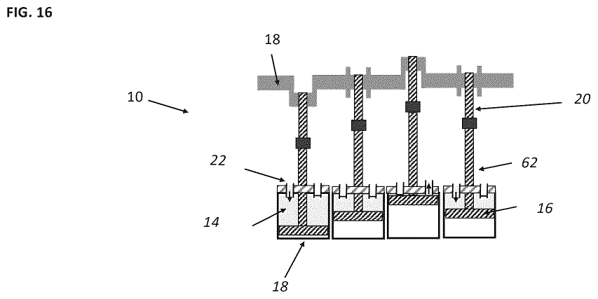

While the rotating crankshaft 18 is below the pistons 16 for vertical cylinders 12 as seen in FIG. 1, herein, a new approach is proposed whereby the crankshaft 18 is above the pistons 16 for vertical cylinders 12, as seen in FIG. 16. This provides an advantage when piston accelerations are similar (or even less than) gravitational acceleration such that a piston rod 62 and the connecting rod 20 are more likely to be in tension than in compression. Since tension-based structural members often allow lower structural mass that a compression-based structural member, this arrangement may allow lower mass for the piston rod 62 and the connecting rod 20. For this configuration, the piston rod 62 is located above the piston face as shown in FIG. 16. This connecting rod can be further partially or fully replaced by a connecting cable or cables if the maximum upward piston acceleration is less than that of gravitational acceleration.

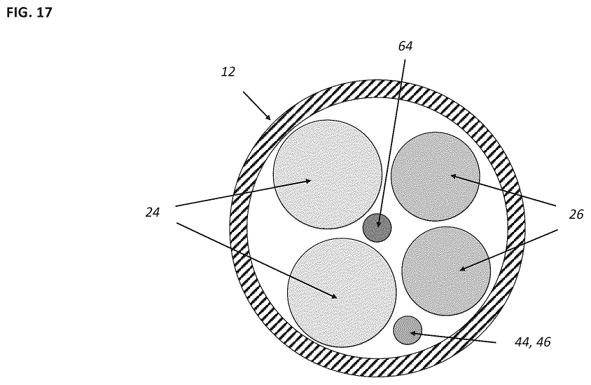

The piston rod 62 passes through a piston rod port 64 in the center of the cylinder head 22, as shown in FIG. 17. The piston rod 62 can be solid or hollow. The piston rod port 64 allows the piston rod 62 to travel up and down but is sealed to minimize any gas leakage. The gas exchange valves (LPV 24 and HPV 26) can be similar to those used in conventional pneumatic compressors (e.g., ring valves, plate valves, Poppet valves, etc.). The valves 24, 26 on the cylinder head 22, can have the arrangement as shown in FIG. 17, where the LPVs 24 are larger than the HPVs 26 (as is conventional for compressors). In addition, the cylinder head 22 can contain one or more pressure relief valves 44 and/or pressure pulsation dampers 46.

For a near-isothermal compression with a centrifugal compressor stage, the spray-based heat transfer concept may be used with pre-mixed injection. Conventional fogging uses mass loadings of 0.5% to 4% with a single injection for all stages of the compressor. However, herein, a novel spray-based approach is proposed whereby a high droplet Mass Loading (5% or more) is combined with low droplet Crowe numbers (e.g., less than one) upstream for an individual compression stage and/or upstream of an individual turbine stage. For a flow through a stage (compressor or turbine stage) with negligible droplet-wall impact during compression, the process time (t_{proc}) can be approximated by the time for stage revolution (t_{stage}), which is based on the stage RPM of the compressor or turbine,

$${t}_{stage} = ( 60 sec / min ) / ( RP {M}_{stage} )$$

Therefore, the “stage Crowe number” is

$$C {r}_{stage} = {t}_{dropT} / {t}_{s t a g e} = {t}_{therm} ( R P {M}_{s t a g e} ) / ( 60 sec / min )$$

As such, Cr<1 requires a combination of low stage RPM and small droplet diameters. For example, a compressor RPM of 6,000 yields a time for stage revolution of t_{stage}=0.01 seconds while droplets with an average diameter of 20 microns have a thermal response time of about 0.0071 seconds. This combination yields a satisfactory stage Crowe number of 0.71. The droplets can be composed of water (e.g., deionized water) or a mixture of ethylene glycol combined with water (e.g., 30% ethylene glycol and 70% water).

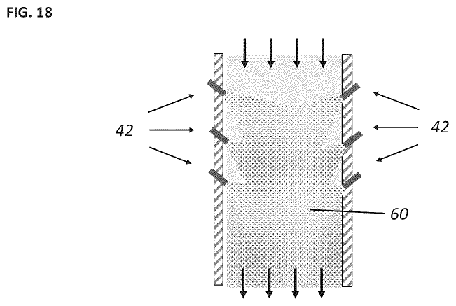

To achieve small droplets uniformly distributed throughout the flow with a high mass loading, one may use an upstream spray pre-mixer pipe flow as shown in FIG. 18, where spray nozzles are located along the side walls and spray towards the middle of the pipe. This droplet-laden flow from this upstream pipe can then be fed directly into a centrifugal or screw compressor stage for compression or into radial or screw expansion stage.

The spray pre-mixer can also serve as a heat exchanger volume to cool the gas after a compression stage and/or to the warm the gas before an expansion stage. In this case, the process time (t_{proc}) is the time the droplet interacts with the gas while in the spray pre-mixer pipe, and the pre-mixer Crowe numbers should be ideally less than unity.

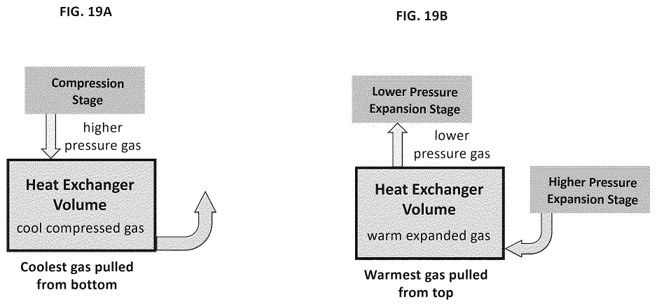

A heat exchanger volume's vertical configuration can also be designed to maximize temperature change. FIG. 19A shows the flow of gas between two stages of a compressor where a low-pressure stage operates at a lower pressure while a high-pressure stage operates at a higher pressure. The warmer gas from the low-pressure stage can be sent to an interstage heat exchanger volume (which acts like an intercooler) before being sent to the high-pressure stage compressor. Since colder gas tends to fall, the lower-stage warmer gas can be injected near the top of the heat exchanger volume and the cooler gas near the bottom of the heat exchanger volume can be sent to the high-pressure compressor stage as shown in FIG. 19A.

For expansion as shown in FIG. 19B, the gas expanded by a high-pressure stage expander can be sent to the interstage heat exchanger volume (which acts like an interwarmer) and then sent to a low-pressure stage expander. Since cold gas tends to fall and since it is desirable to have the warmest gas for further expansion, the colder gas from the high-pressure expansion stage can be injected near the bottom of the heat exchanger volume and the warmer gas near the top of the heat exchanger volume can be sent to the low-pressure expansion stage, as shown in FIG. 19B.

The various embodiments of the reciprocating piston-based near-isothermal gas compressor and/or expander disclosed herein may be used across a variety of industries and applications due to its ability to compress and/or expand gas efficiently. For example, the systems and arrangements disclosed herein are applicable to manufacturing, construction, automotive, energy, and food & beverage industries as well as industries with energy-intensive processes, such as steel, cement, and chemical manufacturing. Oil and gas, transportation, mining, agriculture, military and aerospace comprise additional industries in which the systems and arrangements disclosed herein may be utilized. The energy sector may also benefit considerably from implementation of the present disclosure, particularly, in the areas of natural gas compression, hydrogen compression, and compressed air energy systems. In the following, the above systems and arrangements disclosed herein are considered for the special case of compressed air energy storage.

### 1.3 Conventional Compressed Air Energy Storage

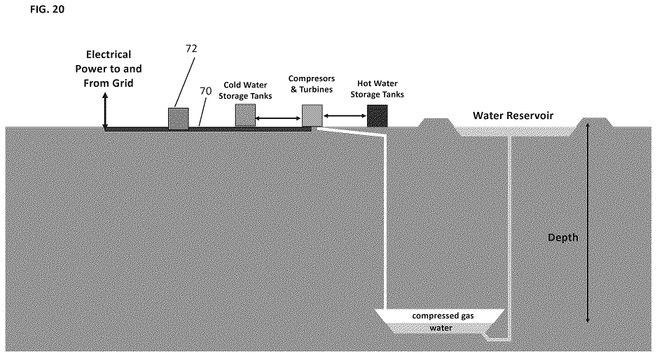

A Compressed Air Energy Storage (CAES) systems can be used to balance supply and demand for an electric grid, where the energy produced by various intermittent generation sources (e.g. wind, solar, etc) can be stored when grid energy is low and regenerated when grid energy demand is high, as shown in FIG. 20. In particular, the generation sources are fed to transmission lines and to the grid and the electric power can be removed or regenerated at the site of the CAES system. The CAES system includes an electrical converter (e.g. transformer 72) to condition the electric energy as medium voltage 70 for one or more electric motors, which converts the electrical power into mechanical rotating shaft power when charging (e.g., when grid demand is low). This shaft power is used to drive one or more compressors in one or more stages, and the resulting compressed air is typically placed in a large underground reservoir, as shown in FIG. 20. This compressed air can then be removed during regeneration to drive one or more turbines in one or more stages. The resulting turbine shaft power can be used to drive generators. The electrical power from the generator(s) can then be conditioned to provide electric power to the grid.

Another common practice for underground CAES systems is to use isobaric pressure storage so the gas pressure stays approximately constant during charging and discharging. This has the advantage of greatly increasing the stored energy density to minimize reservoir volume. To achieve an isobaric system, the air volume reduces as the air leaves the reservoir during discharge. This is conventionally accomplished by using a water reservoir at the surface which is connected to the underground volume so that compensating water volume can be used to replace air volume during discharge (Barnes & Levine, 2019). FIG. 20 shows such a surface water reservoir. For such hydrostatic compensation, the reservoir pressure is proportional to the depth, e.g., a storage pressure of 60 bar would correspond to a depth of about 600 meters.

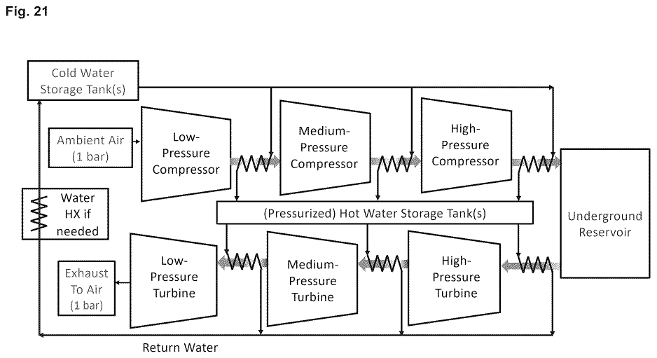

A common version of a CAES system is an Advanced Adiabatic Compressed Air Energy Storage (AACAES) system, where the compression in each stage is approximately adiabatic and the thermal energy from compression is stored and later added during expansion. An example version of AACAES for three-stage compression and three-stage expansion is shown in FIG. 21. The produced heat after each compression stage is harvested with heat exchangers and stored in a thermal storage system (e.g., a hot water tank, which is often pressurized to prevent boiling). When grid demand is high, the compressed gas from the reservoir is then heated from the thermal storage system before being fed into each expansion stage. This added heat increases the power produced by each stage of expansion.

### 1.4 Isobaric Reservoirs and Isothermal Compressed Air Energy Storage

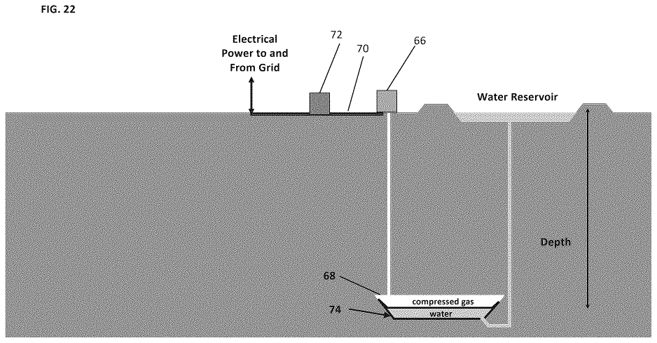

As discussed in Section 1.3, an isobaric CAES system provides increases in the underground reservoir energy density. This can be connected to the electric grids with voltage transformers 72 to condition the voltage 70 as it goes to and from the motor/generator of the compressor/expander system 66. However, one issue is that the compressed air in the underground reservoir can be lost as dissolved gas in the water that is also in the reservoir. This dissolved gas can then be released as the water moves to the surface and the pressure drops. The release of this dissolved gas at the surface reservoir represents lost energy and thus reduces the amount of compressed air energy storage. To reduce or eliminate this problem, a flexible bladder 74 can be placed in the underground reservoir 68 as shown in FIG. 22 so that the water fills this bladder 74 when entering and direct contact with the compressed gas is avoided, thereby avoiding (or at least minimizing) gas dissolution into the water. A “flexible bladder” refers to a sealed and pressure-compliant container, whose volume can change as liquid is added or withdrawn. For example, this bladder 74 can be made of a polyurethane material since this material is robust and can support operating temperatures as high as 80° C. to 90° C.

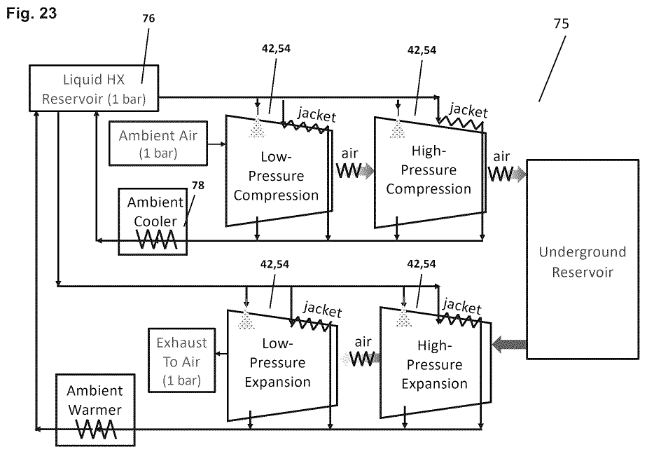

If a CAES system employs near-isothermal compression and expansion system 66, as discussed in Section 1.2 and shown in FIG. 22, this combination is termed herein as Isothermal Compressed Air Energy Storage (ICAES). An advantage of a near-isothermal system is that the thermal energy storage system (as used in AACEAS) is no longer needed, which reduces cost and complexity of the system. An example of an ICAES system 75 for two-stage compression and two-stage expansion is shown in FIG. 23, where a liquid reservoir 76 is used to supply liquid for spraying droplets. The compression can be accomplished with single-acting piston chambers 14 and/or double-acting piston chambers 13 and 15. The cylinders can include liquid jackets 54 around the cylinders 12. Throughout charging via air compression, this heated liquid (after passing by and/or in the compression cylinders) can be continually sent to an ambient cooling heat exchanger 78 and recirculated through the liquid reservoir 76 so it can be sent back into the spray and/or liquid jacket systems 42, 54. Throughout discharging, this cooled liquid (after passing by and/or in the expansion cylinders) can be continually sent to an ambient warming heat exchanger 78 (or a heat exchanger that takes advantage of geothermal warming deep underground) and recirculated through the liquid reservoir 76 so it can be sent back into the spray and/or liquid jacket systems 42, 54. In addition, air-cooled heat exchanger volume(s) can be used after each compression stage as shown in FIG. 23. Similarly, air-warming heat exchanger(s) volume(s) can be used before each expansion stages as shown in FIG. 23. These heat exchanger volumes can also use spray-based heat transfer as shown in FIG. 18. For such an ICAES system, no thermal storage tanks are needed.

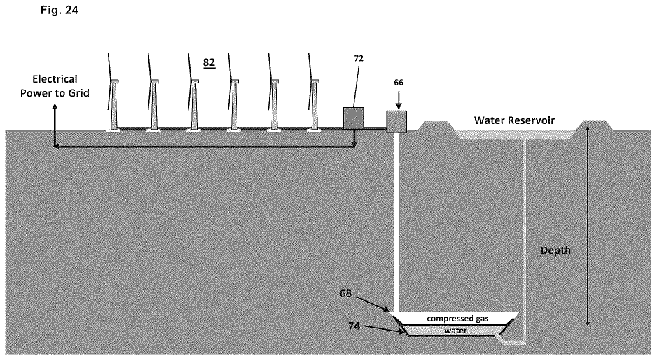

Another option is to co-locate the CAES system at a wind farm 82 as shown in FIG. 24. Such co-located storage avoids the cost of a step-down transformer (since the system can directly use medium voltage from the wind turbines) and avoids the extra cost of a step-up transformer (since it can use the step-up transformer 73 already located at the wind farm 82). Co-location also avoids the costs and energy losses associated with routing transmission lines to and from a grid-based storage CAES site, which can be significant if the CAES site is not located near an existing grid node with high throughput capacity. Co-located storage is also less likely to be subject to congestion effects, since energy prices and demands tend to be high when wind farm energy generation is low, so the wind farm transmission lines are unlikely to be congested. As shown in FIG. 24, such co-location can employ an isobaric reservoir 68 with a flexible water bladder 74 for the water.

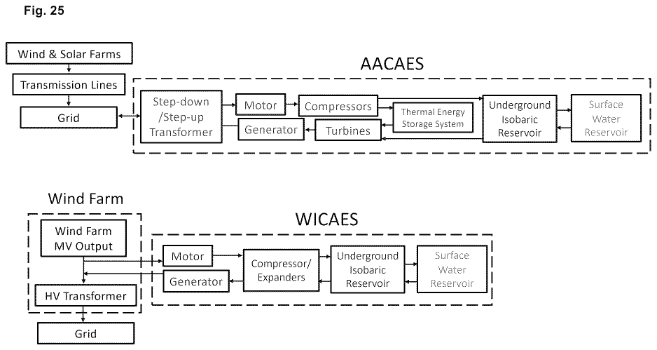

If the system employs near isothermal compression and expansion, as discussed in Section 1.2, this combination is termed Wind-based Isothermal Compressed Air Energy Storage (WICAES). The components of such a system are compared to that of a conventional AACAES system in FIG. 25. It can be seen that the WICAES system does not need a Step-down Transformer and employs the existing Step-Up Transformer already located at a wind farm. This can save system costs. In addition, the WICAES system does not need a Thermal Energy Storage System, which can further save system costs.

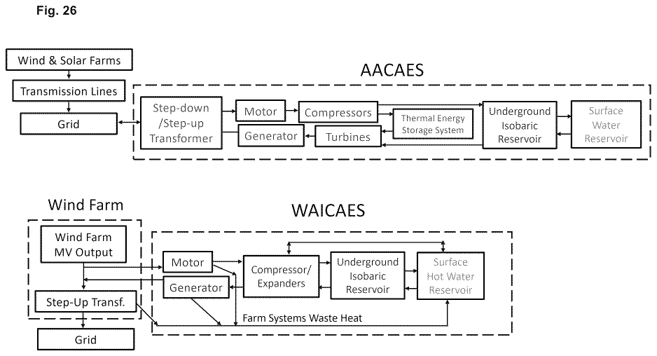

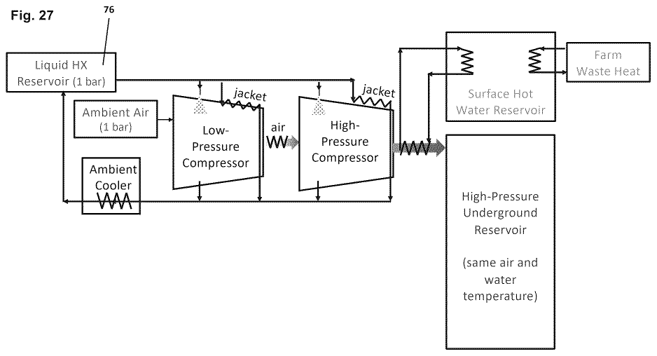

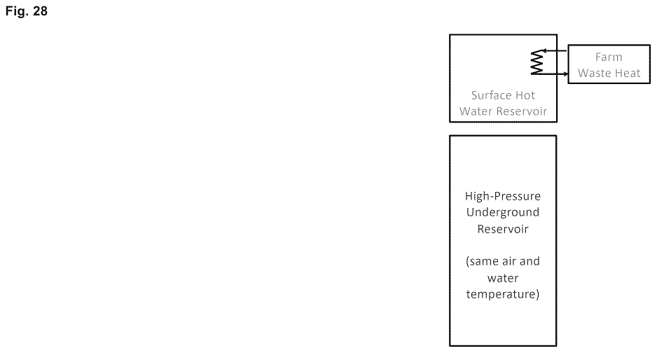

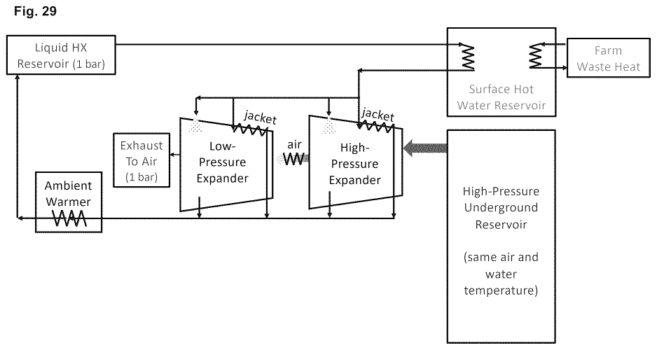

A potentially beneficial modification to WICAES is to harvest the waste heat from the farm-level equipment (transformers, motors, generators, gearboxes, etc.) as well as to harvest the heat from the air compressors. This harvested heat can be used to supply thermal energy to the surface water reservoir as shown in FIGS. 26 and 27, so that it becomes a surface hot water reservoir. During storage, harvest waste heat from the farm-level equipment (transformers, motors, generators, gearboxes, etc.) can continue to supply thermal energy to the surface water reservoir as shown in FIG. 28. During discharging, the hot water surface reservoir can be used to provide thermal energy to the reciprocating expansion systems in the form of spray-warming and/or liquid jacket warming as shown in FIG. 29.

An advantage of having a hot water reservoir is that the air from the compressors (after heat exchange with the reservoir water) can be delivered to the underground reservoir at a similar temperature as the that of the hot water reservoir. For example, the compressed air in storage and the hot water reservoir can both be at a temperature of about 50° C. or 60° C. As such, the underground reservoir can be both isobaric and isothermal since the gas and air are at nearly the same temperature and pressure. In this way, the surrounding underground reservoir walls can also be at nearly this same constant temperature, which reduces thermal stresses. In addition, this allows thermal energy storage within the gas, since it is stored at a higher temperature than ambient temperature. This combination is termed Wind-based Advanced Isothermal Compressed Air Energy Storage (WAICAES) since it takes advantage of waste heat harvesting using the surface reservoir and the underground reservoir as thermal storage systems.

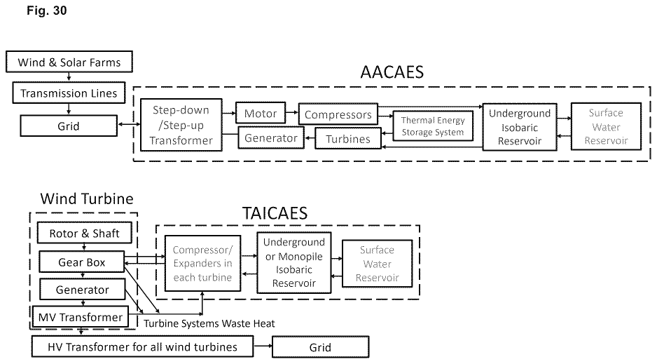

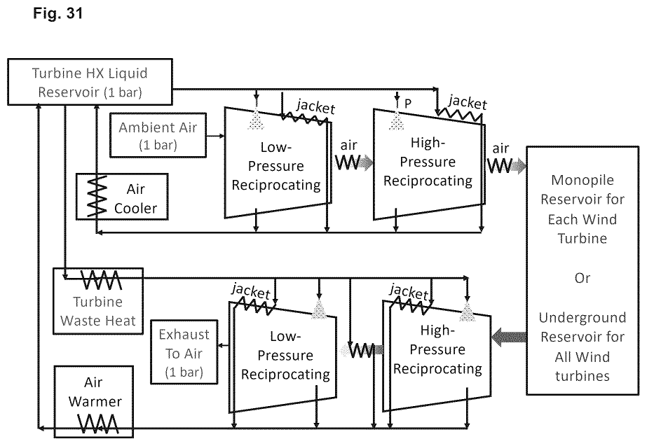

An even more integrated option is to have each of the wind turbines include their own individual compressor/expander system. The compressed gas from all the wind turbines can then collected in one or more underground reservoirs, which can be isobaric, as shown in FIG. 30. If the compression/expansion systems in each of the turbines employs near isothermal compression, this combination is termed Turbine-integrated Isothermal Compressed Air Energy Storage (TICAES). However, if one also integrates waste heat harvesting from the turbine-level equipment (gearbox, generator, transformer, etc.) during discharge to provide thermal energy to the reciprocating expansion cylinders of spray-warming and/or liquid jacket warming as shown in FIGS. 30 and 31, this combination is herein termed Turbine-integrated Advanced Isothermal Compressed Air Energy Storage (TAICAES).

For a turbine-integrated CAES approach, one may locate the compressor/expander system in or near the nacelle and/or one may locate the compressor/expander system in or near the tower base.

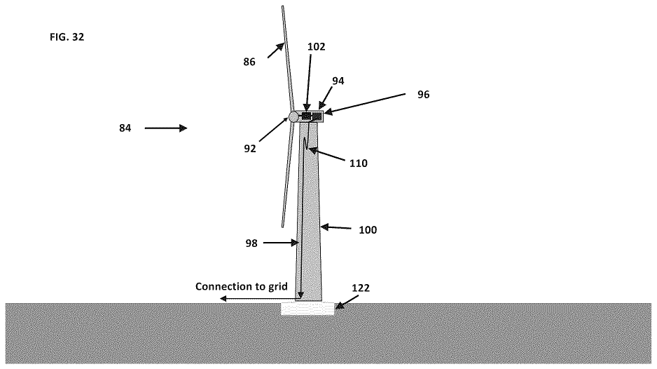

Before considering these two location options, we first note that a conventional onshore wind turbine 84 has a configuration as shown in FIG. 32. For conventional wind turbines, available wind energy is used to rotate a rotor 86 facing the wind, which is connected to the main rotor shaft 90 by a hub 92. This shaft power is fed into an electrical generator 94 in a nacelle 96 (and often a transformer 97 as well), and the resulting electric power is then sent by electric cables 98 down the tower 100. Generally, several wind turbines 84 are sited together to comprise a wind farm and the net electric power from all the turbines is sent by transmission lines to the grid.

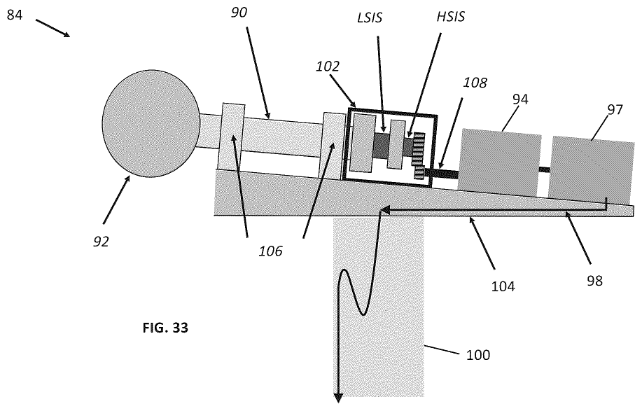

For a conventional geared wind turbine (often used for onshore wind farms), the main rotor shaft 90, also termed the Low-Speed Shaft (LSS), is supported by two main bearings 106 before being connected to a gearbox 102 as shown in FIG. 33. This gearbox 102 generally has a high gear ratio, e.g. 80-120, so that the resulting High-Speed Shaft (HSS) 108 can drive an electrical generator. Often there are two intermediate speed shafts within the gearbox: the Low-Speed Intermediate Shaft (LSIS) and the High-Speed Intermediate Shaft (HSIS). All these components generally rest on a bedplate 104 as shown in FIG. 33 (though the transformer 97 can also be at the base of the turbine). This bedplate 104 can rotate about a vertical axis so that the rotor 86 faces the wind, where this vertical-axis rotation is referred to as yaw rotation and is driven by a yaw motor. A set of electrical cables 98 carries the generated electrical energy down the tower 100. To accommodate the yawing of the bedplate 104, the electrical cables 98 often have drip loop 110 as shown in FIGS. 32 and 33.

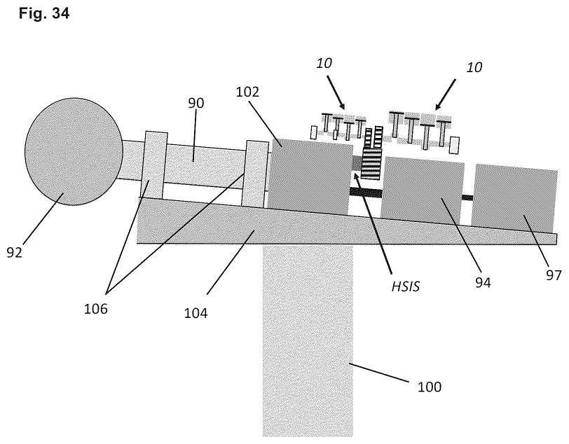

For a Turbine-Integrated system (TICAES or TAICAES), the compressor/expander system can be connected to one of the shafts of the wind turbine drive train. By integrating the compressor/expander system into the nacelle, the turbine-integration approach eliminates the need for an electrical converter and a motor, and employs the existing gearbox, generator and transformer (as shown in FIG. 30). The compressor/expander system can use a reciprocating system as in FIGS. 1-5. For example, the crankshafts 18 for a reciprocating system 10 can be set above the main shaft 90 and geared from the High-Speed Intermediate Shaft (HSIS) as shown in FIG. 34. One or more crankshafts 18 can also be placed to the sides of the main shaft 90 or below the main shaft 90. The cylinders 12 can be placed above a crankshaft 18 as shown in FIGS. 1 and 34 or below the crankshaft 18 as shown in FIG. 16 or to the side of the shaft for a horizontal cylinder as shown in FIGS. 14 and 15.

For a centrifugal/axial compressor or a radial/axial turbine that requires a high RPM (with upstream spray heat transfer as shown in FIG. 18), the integration can be to the HSS. In addition, different compressor/expander system can be integrated together. For example, a centrifugal compressor/turbine can be used for the first stage with a reciprocating compressor/expander for the second stage.

To allow the cylinders to be vertical, bevelled gears can be used to eliminate the effect of shaft tilt (relative to the horizon) due to possible tilt of the wind turbine rotor 86. In addition, the wind turbine rotor 86 acts as a flywheel to ensure steady rotational speeds.

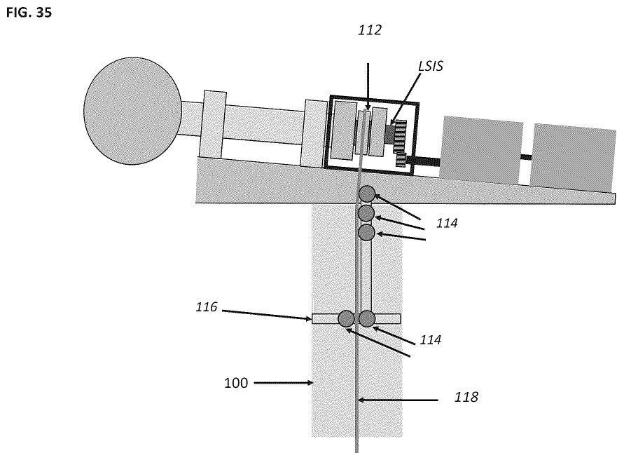

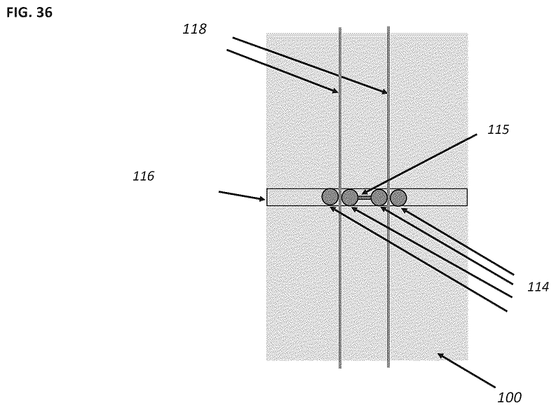

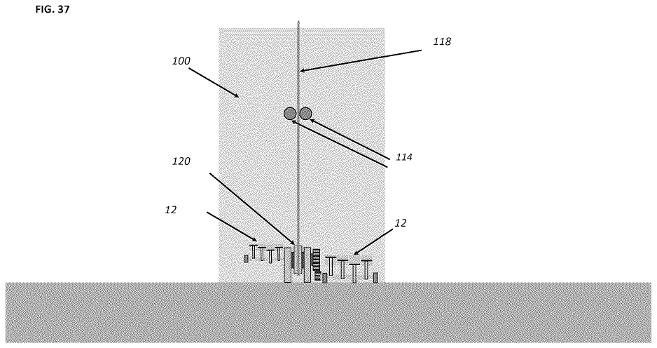

Another option is to integrate the compressor/expander system at or near the tower base. This can be accomplished by using a drive cable system 118 that connects one of the rotating shafts in or near the nacelle to a rotating shaft at or near the tower base. For example, a Top Bullwheel 112 can be mounted on the LSIS as shown in FIG. 35, where sheaves 114 mounted on a yawing sheave ring 116 are used to align the drive cable 118 with the tower centerline. This cable system 118 may be allowed to twist within the tower 100 to accommodate yawing of the nacelle 96 as shown in FIG. 36, where a sheave spacer 115 can be used to ensure the up and down drive cable do not contact each other. At the turbine base, a Bottom Bullwheel 120 can be used to connect the drive cable 118 to a compressor/expander system 10 as shown in FIG. 37.

An issue to consider with a turbine-integrated CAES system is the interaction of hydraulic and/or pneumatic lines with the electrical cables. Electrical cables 98 are used to carry the electrical energy from the nacelle 96 (starting at the generator 94 or the transformer 97) and pass through the tower 100 and then exit the tower 100 near the foundation 122, as shown in FIG. 32. To accommodate bedplate yaw, the electrical cables 98 are located near or at the center of the vertical axis of rotation and allowed to twist as the nacelle 96 rotates. To facilitate this twist, a drip loop 110 is typically used for the electrical cables 98 as shown in FIGS. 32 and 33.

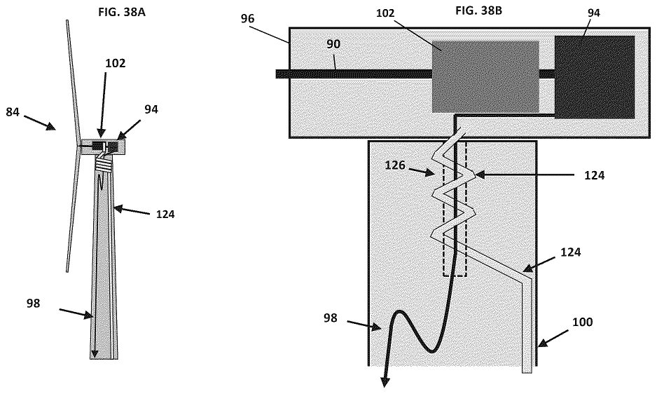

For a turbine-integrated compressor/expander system in or near the nacelle 96, the compressed gas must flow from the yawing nacelle 96 down to the stationary tower base through pressurized pneumatic lines. In addition, hydraulic lines may be used to allow heat exchanger fluid to go between the nacelle and the tower base. These hydraulic and/or pneumatic lines 124 may have portions which are flexible to accommodate yaw movement of the nacelle 96 and avoid impact with the electrical lines 98. In particular, the hydraulic and/or pneumatic lines 124 can be coiled inside the top of the tower 100 as shown in FIG. 38, where each additional yaw rotation will result in one more or one less coils, depending on the direction of the coils. The electrical cables 98 and the hydraulic and/or pneumatic line(s) 124 can then separately run along different sides to the internal tower shell as shown in FIG. 38A. To ensure the hydraulic and/or pneumatic line(s) 124 never contact the electrical lines 98, a wrap mesh 126 can also be used as shown in FIG. 38B.

While the above concepts were described for a conventional onshore geared turbine, they can also be used for a direct-drive wind turbine. For a direct-drive wind turbine, there is no gearbox, and the main shaft is instead connected to a direct-drive electrical generator, which has the same low RPM as the main shaft. For such a system a low-speed compressor/expander energy storage system may be preferred. The main shaft, generator rotor and generator are all typically located in front of the tower so that the upwind gravitational moment can help counteract the downwind thrust moment. In this case, a compressor/expander system located in or near the nacelle may be best integrated by connecting to the main rotor shaft in front of the direct-drive generator. A bevelled gear (or gears) can be used for this connection to allow the cylinders to be vertical if there is rotor tilt. For a compressor/expander system located in or near the tower base, an intermediate speed gear connected to the main rotor shaft can be placed below the generator and used to drive a Top Bullwheel as in FIG. 37.

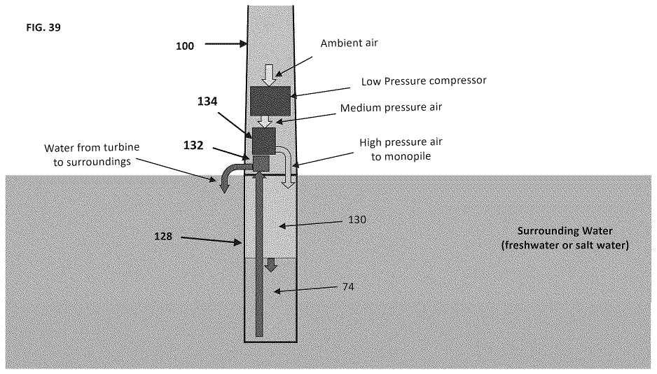

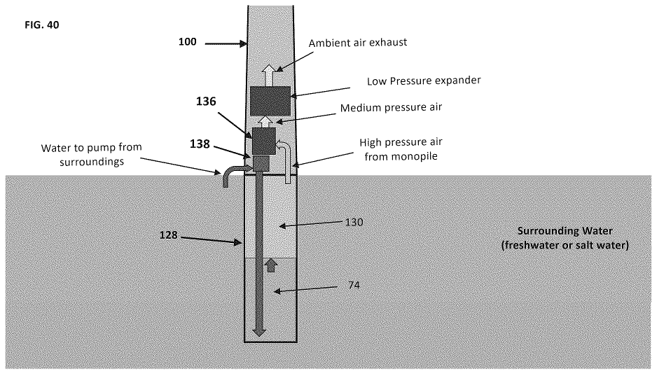

An advantage for an offshore system is that the surrounding water can provides an ample supply of liquid to be used for volumetric makeup for an isobaric high-pressure reservoir that is near the tower base (not deep underground) by adding a hydraulic pump/turbine. For example, a monopile 128 can be used as the storage volume 130 for the compressed air and for high-pressure water 74 to allow isobaric storage as shown in FIGS. 39 and 40. During charging, the final (high-pressure) compression stage(s) 134 can be connected to and powered by a hydraulic turbine 132, which is driven by the high-pressure liquid leaving the storage volume. During discharging, the initial (high-pressure) expansion stage(s) 136 can be connected to and drives a hydraulic pump 138. The water in the monopile can be stored in one or more flexible bladders as shown in FIGS. 39 and 40. One may also use a movable interface with a circular cross-section to help separate the gas and liquid volumes to avoid gas dissolution issues.

However, the monopile can also be used for isochoric storage to avoid the need for compensating water to enter the monopile. For isochoric storage in the monopile with an elevated gas temperature, the monopile can include an insulating liner to avoid heat losses to the ambient surroundings.

### 1.5 Notes

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. Terms such as “connected to”, “affixed to”, etc., can include both an indirect “connection” and a direct “connection.”

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### REFERENCES

The following patents, applications and publications as listed below and throughout this document are hereby incorporated by reference in their entirety herein, and which are not 5 admitted to be prior art with respect to the present disclosure by inclusion in this section.
S. Barnes & J. G. Levine. Large Energy Storage Systems Handbook, CRC Press, 2019.
Simpson, J., Qin, C, and Loth, E. (2023a) Spray-cooled compression: Theory and simulation. Applied Thermal Engineering, Volume 229, 5 Jul. 2023, 1206.
Simpson, J., Qin, C, and Loth, E. (2023b) Predicted roundtrip efficiency for compressed air energy storage using spray-based heat transfer. Journal of Energy Storage 72, 108461, 3.

What is claimed:

1. A gas compressor system, comprising:
at least one stage of the compressor having one or a plurality of cylinders each with a mechanical piston coupled to a crankshaft whereby rotation of the crankshaft drives each piston in a reciprocating manner to provide mechanical compression or expansion of a gas in a cylindrical chamber
a fluid volume inside the chamber of each cylinder where a volume of the gas varies upon movement of the piston and a timing of valves, where the piston is single-acting having one fluid volume per cylinder or double-acting having two fluid volumes per cylinder,
wherein an internal liquid volume is also included in the chamber and this liquid volume comprises between 1% and 30% of the maximum chamber fluid volume;
wherein each cylinder chamber includes at least one low-pressure valve to draw in low-pressure gas and at least one high-pressure valve to exhaust high-pressure gas from the chamber.

2. The system of claim 1, wherein the low-pressure valve remains closed when the piston is receding from the cylinder chamber until a gas pressure in the chamber reduces to a level that is similar to that of the low-pressure gas.

3. The system of claim 1, further comprising spray nozzles configured to inject droplets where the nozzles are disposed along a wall of the chamber for in-cylinder injection and/or are disposed in the passage that is upstream of the chamber for pre-mixed injection.

4. The system of claim 3, for a pre-mixed injection, further comprising a valve stem for the upstream flow that is configured to spin about an axis of symmetry when the valve is open to induce a swirl of gas in a valve passage to reduce the impact of pre-mixed droplets on valve surfaces as the droplets enter the chamber.

5. The system of claim 1, further comprising porous elements disposed in the chamber near the low-pressure and high-pressure valves, wherein the porous elements are configured to provide heat transfer to and from the gas, and wherein the liquid in the chamber submerges most of the porous elements in the chamber when the piston is closest to the valves.

6. The system of claim 5, wherein the porous elements are composed of a material with a high thermal conductivity and are connected as a network to one or more walls of the chamber to promote heat transfer.

7. The system of claim 5, wherein the porous element are shaped to comprise one or more of the following configurations: wire mesh, a hexagonally-shaped mesh, longitudinal cylindrical tubes, and longitudinal slats (along straight lines, wavy lines, concentric circles, and/or radial lines).

8. The system of claim 5, and where the porous elements have longitudinal gaps between sections of porous elements to restart thermal boundary layers, and/or have smaller and/or more closely spaced features for porous element sections that are near the valves.

9. The system of claim 5, wherein the porous elements or chamber surface features are arranged to promote swirl of the liquid in the chamber to minimize liquid sloshing and/or impact of liquid to the valves.

10. The system of claim 1, wherein the crankshaft and connecting rods are placed above the cylinders and a piston rod is attached to a top of each piston face and passes upward through a cylinder head though a sealed piston port to connect to each connecting rod.

11. The system of claim 1, wherein a heat exchanger volume is configured for compressor operation so that warmer gas is fed in at a top of the heat exchanger volume while cooler gas exits at a bottom and/or wherein the heat exchanger volume is configured for expansion operation so that warmer gas exits at the top while the cooler gas is fed in at the bottom.

12. A pressurized reservoir for compressed gas configured to allow approximately isobaric operation wherein compensating water leaves the reservoir as compressed gas enters the reservoir and compensating water enters the reservoir as the compressed gas leaves the reservoir, wherein the water in the reservoir is contained within one or more flexible bladders to prevent high-pressure gas dissolution into the water.

13. The system of claim 12, wherein the pressurized storage chamber air and/or the compensating water are maintained at an elevated temperature relative to an ambient environment (in order to store thermal energy that can be used during energy regeneration).

14. The system of claim 12, wherein the system is configured to achieve an elevated temperature of the compensating water by harvesting the gas heat available during or after a gas compression stage and/or the waste heat from one or more of the following: the compressed air energy equipment, and/or wind farm electrical equipment.

15. The system of claim 12, wherein the elevated temperature of a compensating water volume is approximately equal to a temperature of the compressed gas volume to help maintain elevated temperatures of both the gas and the water and to reduce thermal stresses.

16. The system of claim 12, wherein liquid droplets with a mass flow rate of 5% or more relative to a gas mass flow rate are injected upstream of a compression stage or an expansion stage where the average droplet size is small enough so that an average droplet thermal response time is similar to or less than a time per revolution of the stage.

17. The system of claim 12, wherein the compression and/or expansion is integrated within or disposed near a wind turbine, and wherein one or more stages of the compressor are driven by local mechanical shaft power of the wind turbine and/or one or more stages of the expander provide power to the electrical generator of the wind turbine.

18. The system of claim 12, wherein waste heat of the wind turbine gearbox and/or generator and/or transformer heats compressed air before and/or during a gas expansion stage.

19. The system of claim 1, where the compressor/expander crankshafts are connected to a cable system in a tower of the wind turbine which includes a Bottom Bullwheel at or near a base of the turbine and a Top Bullwheel connected to one of the mechanical shafts in or near a nacelle of the wind turbine.

20. The system of claim 19, wherein cable twist due to nacelle yaw is accommodated by yawing sheaves at a top of the tower, fixed sheaves at a bottom of the tower, and one more rotatable sheaves in a middle of the tower wherein the sheave system is arranged to allow nacelle yaw and to prevent the up and down portions of the drive cable from coming into contact with each other.

21. The system of claim 12, further comprising hydraulic and/or pneumatic lines from a nacelle to a tower base of the wind turbine, wherein, to accommodate nacelle yaw, the hydraulic and/or pneumatic lines are coiled inside a top portion of the tower and where swivel connections can be used to minimize line twist of the hydraulic and/or pneumatic lines.

22. The system of claim 12, wherein one or more heat exchanger volumes are wrapped around an outside of a tower and/or monopile of a wind turbine to utilize the shell thermal capacity and/or to utilize convective heat transfer associated with ambient wind or water current.

23. The system of claim 12, wherein the wind turbine comprises an offshore wind turbine comprising a monopile acting, at least in part, as an isobaric reservoir wherein compensating water from the surrounding enters the monopile as the compressed gas leaves the monopile and wherein compensating water leaves the monopile and goes back to the surrounding as compressed air enters the monopile.

24. The system of claim 23, wherein one or more stages of a hydraulic turbine are configured to extract power as the high-pressure water leaves the monopile reservoir and goes to the ambient surrounding water and wherein the hydraulic turbine is also configured to drive one or more stages of an air compressor to provide high-pressure air that enters the monopile reservoir.

25. The system of claim 24, further comprising one or more stages of a hydraulic pump to send ambient surrounding water into the monopile reservoir, where the hydraulic pump is powered by one or more stages of the air expander that extracts energy from the high-pressure air leaving the monopile reservoir.

26. The system of claim 1, wherein the wind turbine monopile acts, at least in part, as an isochoric reservoir for compressed air energy storage with the option of a thermally-insulating liner within the monopile to avoid heat losses to the ambient surroundings.
